(19) United States
(12) Patent Application Publication
(10) Pub. No.: US 2004/0042750 A1
(43) Pub. Date: Mar. 4, 2004

(54) Clay nanocomposite optical fiber coating

(76) Inventors: Gunilla E. Gillberg, Painted Post, NY (US); Jun Hou, Painted Post, NY (US); Eric J. Mozdy, Elmira, NY (US); Huan-Hung Sheng, Charlotte, NC (US)

Correspondence Address: CORNING INCORPORATED, SP-TI-3-1, CORNING, NY, 14831

(21) Appl. No.: 10/215,708

(22) Filed: Aug. 9, 2002

Related U.S. Application Data
(63) Continuation-in-part of application No. 10/202,692, now abandoned.

(51) Int. Cl. G02B 6/22

(52) U.S. Cl. 385/128

(57) ABSTRACT

Optical fibers are coated with a clay-polymer nanocomposite composition comprising optionally a hydrophobic layered silicate dispersed in a radiation curable resin preferably on a molecular level. The radiation curable resin may contain a mixture of a radiation curable oligomer and a diluent(s). The coating when cured has improved tensile properties, and when used as an outer primary coating exhibits low microbending sensitivity.

### CROSS-REFERENCE TO RELATED APPLICATIONS

This application is a continuation-in-part of U.S. patent application Ser. No. 10/202,692, filed Jul. 24, 2002, the content of which is relied upon and incorporated herein by reference in its entirety.

### BACKGROUND OF THE INVENTION

1. Field of the Invention

The present invention relates generally to optical fiber coating compositions and particularly to a clay-polymer nanocomposite composition, especially useful as an outer primary coating for optical fibers.

2. Technical Background

The main component of optical glass fibers is ultra-pure silica. Pristine fibers are brittle and therefore are generally protected and strengthened by two coating layers: one layer is termed an inner primary coating (also known as a primary coating), and the other is termed an outer primary coating (also known as a secondary coating). The aforementioned coatings are typically radiation curable coatings. To better protect the optical fibers, it is generally agreed that a soft inner primary coating coupled with a hard outer primary coating is desirable. The inner primary coating layer is directly applied to the fiber surface to serve as buffer to cushion and protect the fiber to relieve stresses in processes such as bending, cabling, and spooling. The outer primary coating, on the other hand, is applied over the inner primary coating to prevent damage to the fiber during processing and use. Typically, the outer primary coating has a higher modulus and glass transition temperature than the inner primary coating.

An important goal of optical fiber coatings is to prevent the fiber from exhibiting microbend induced losses. Much confusion exists about the definition of microbending versus macrobending for optical fibers; in fact, the same environmental conditions can cause either type of loss, depending upon the index profile of the optical fiber. As used herein, microbending and macrobending will be defined based on the underlying physical causes of the optical loss due to bending. More specifically, macrobending loss can be modeled by fundamental (guided) mode evanescent wave leakage from the fiber core into the cladding. A typical scenario for macrobending is a constant curvature bend, or a set of bends that can be modeled as slowly-varying curvature, such that the claddin gindex is elevated enough to allow optical confinement (i.e. the cladding index exceeds the effective index of the propagating mode in the core), thereby drawing power from the core mode. Microbending loss, on the other hand, typically results from environmental perturbations that cannot be described or modeled as constant curvature loss. Typically, this involves more rapid, usually stochastic changes in fiber curvature that ore more effectively modeled with coupled-mode theory. Many theorists also sometimes use a nonzero second derivative of the fiber's radius of curvature as a litmus test for the presence of microbending. Microbending therefore physically looks like a large collection of bends of 10 μm -10 mm bend arc length, and bend amplitude ranging from only a few nm to hundreds of μm (all parameters being dependent on fiber design).

Microbending causes attenuation of the light traveling through the fiber and results in inefficient signal transmission or the need for amplificiation. Microbend attenuation can be induced in a thermal process, for instance, buckling at low temperatures due to differences in the coefficient of thermal expansion (CTE) between inner and outer primary coatings or between the inner primary and the glass. In order to reduce or eliminate thermally induced optical losses, compositions resulting in highly flexible inner primary coatings with good adhesion to the optical fibers, or inner primary coatings with low tensile modulus at low temperatures have been proposed. Examples of such compositions are disclosed in the specifications of JP01188549A2, JP60251152A2, U.S. Pat. No. 4,609,718, U.S. Pat. No. 4,608,409, EP166926A2 and EP124057A1. However, this strategy is limited due to processing issues. A low Young's modulus inner primary coating has a tendency to tear at higher processing speeds, such as draw speeds which exceed 20 m/s.

Microbend attenuation can also be induced by external forces such as lateral forces or constant displacements on the spool or in the cable. External force induced microbend attenuation can be reduced by selecting a stiff, tough, or low-shrinkage outer primary coating composition. Generally, high modulus outer primary coatings are obtained by increasing the cross-linking density of the coating. This, however, also generally results in a more brittle and less processable coating.

Despite all of the above efforts, reducing microbending attenuation in optical fibers remains a challenge to those in the field of optical fiber coatings. New coating systems with optimized microbend resistance are becoming increasingly needed, especially for many of the new high value-added fibers such as those with a large effective area with their intrinsic greater microbend sensitivity.

### SUMMARY OF THE INVENTION

One aspect of the invention includes an optical fiber coating composition. The composition may include an UV curable composition. Preferably the UV curable composition includes no more than about 55 weight percent of an acrylate oligomer and a substantially exfoliated clay. Preferably when cured, the composition has a Young's modulus of at least about 100 MPa at room temperature.

In another aspect, the present invention includes a coated optical fiber. The coated fiber comprises an optical fiber having a core and at least one surrounding glass region of refractive index lower than a refractive index of the core. The fiber further comprises a cured coating which comprises no more than about 55 weight percent of a cured acrylate oligomer and a substantially exfoliated clay, encircling the cladding. Preferably the cured coating has a Young's modulus of at least about 100 MPa at room temperature. This aspect of the invention may also include a method of making the aforementioned coated optical fiber. The method comprises applying the aforementioned coating composition to the fiber.

In a further aspect, the invention includes a method of making an optical fiber coating composition. The method includes the steps of (1) dispersing a clay into a low viscosity mixture forming a nanocomposite; (2) milling the nanocomposite forming a mill; (3) collecting the mill; (4) blending an effective amount of a high viscosity component into the mill to form the composition; and (5) filtering of the composition.

An additional aspect of the invention includes a method of dispersing a perpendicular force applied to a coated optical fiber. The method includes the steps of coating an exterior surface of an optical fiber with a first coating; applying an UV curable coating composition which comprises no more than about 55 weight percent of an acrylate oligomer and a substantially exfoliated clay to the first coating; and curing the UV curable coating composition. The cured coating has a Young's modulus of at least about 100 MPa at room temperature. The method also includes the step of applying a perpendicular force to the fiber.

Another aspect of the invention includes an apparatus for the measurement of an optical property of an optical fiber segment having an input end and an output end, the apparatus including an optical source coupled to the input end of the optical fiber segment; a pair of opposing rack elements including a first rack element and a second rack element, the pair of rack elements being configured to engage the optical fiber segment; and an optical detector coupled to the output end of the optical fiber segment.

Another aspect of the invention includes a method of measuring an optical property of an optical fiber segment having an input end and an output end, the method including the steps of: coupling an optical signal from an optical source to the input end of the optical fiber segment; engaging the optical fiber with a pair of opposing rack elements; coupling the optical signal from the output end of the optical fiber segment to an optical detector; and detecting the optical signal with the optical detector.

It is an advantage of the present invention to provide a new nanocomposite coating composition with enhanced mechanical properties and suitable for use as an outer primary optical fiber coating. It would also be advantageous to use such compositions for optical fiber inks or ribbon matrices. Preferably, one embodiment of the coating composition contains an organically modified swellable clay, known herein as an organoclay, that is dispersed in a radiation curable resin, preferably on a molecular level. The radiation curable resin can be any combination of radiation curable diluent(s) and an oligomer that is processable in a typical continuous on-line optical fiber coating apparatus. The clay can be any swellable layered silicate, either natural or synthetic, including, but not limited to, montmorillonite, hectorite, fluorohectorite, fluromica, vermiculite. The organic species used to modify the clay can be any substance that is positively charged, or that can be transformed into a positively charged species, including primary, secondary and tertiary alkyl amines, pyridines, and quaternary ammonium and pyridinium salts of halides, sulfates, nitrates, acetate, and methylsulfates, as well as the sulfonium or phosphonium analogs. Other methods, such as using silane, titanate or zirconate coupling agents, or in situ radical polymerization in the presence of layered silicates, etc., might be used to produce the organoclays, which can be dispersed in an optical fiber coating.

Another advantage of the invention is to provide a nanocomposite composition to reduce cabled optical fiber attenuation losses caused by microbend and/or to a certain degree macrobend sensitivity of the optical fiber. Yet another advantage of the invention is to provide a nanocomposite coating with improved barrier properties to gases, moisture, and organic solvents, enhanced thermal, flame-retardant properties, improved coefficient of friction, and resistance to scratch and abrasion.

One preferred embodiment of the uncured nanocomposite composition may comprises the following:

from 0 to 55% by weight of a radiation curable oligomer;

from 0 to 80% by weight of a reactive diluent or a mixture of diluents;

from 0 to 40% by weight of a photoinitiator;

from 0.1 to 25% by weight of an organoclay; and

optionally, 0 to 10% by weight of an antioxidant.

When cured, the inventive coating composition preferably has a room temperature Young's modulus of at least about 100 MPa, an elongation at break of at least about 3%, and a glass transition temperature (tan delta max) of at least about 20° C. The nanocomposite coating composition, when coated and cured on an optical fiber, may advantageously result in fiber coatings having improved fiber coating concentricity and enhanced microbend resistance.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed.

The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a cross sectional view of a coated optical fiber in accordance with the present invention.

FIG. 2 is a schematic elevated view of an embodiment of a method of making a coated optical fiber.

FIGS. 3 and 4 are schematic representations of the dispersion of a perpendicular force applied to a fiber with the inventive coating and a control fiber.

FIGS. 5-7 are charts of results of the rack test of the inventive composition plotted as loss (dB) versus wavelength (nm).

FIG. 8 is a schematic view of a rack element.

FIG. 9 is a top schematic view of a rack test.

### DETAILED DESCRIPTION OF THE PREFERRED EMBODIMENTS

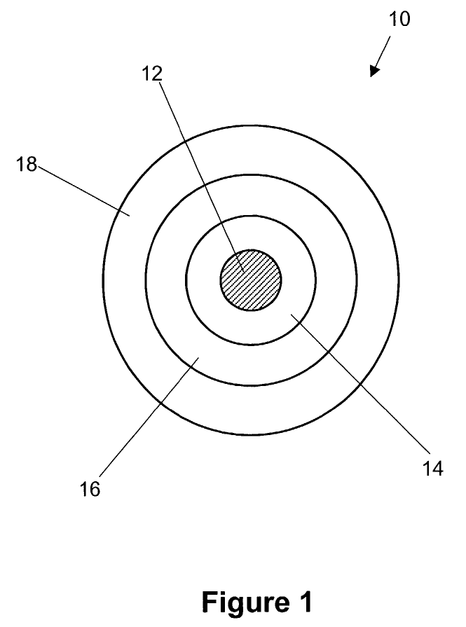

Reference will now be made in detail to the present preferred embodiment(s) of the invention, examples of which are illustrated in the accompanying drawings. Whenever possible, the same reference numerals will be used throughout the drawings to refer to the same or like parts. An embodiment of the invention for an optical fiber coating composition in the form of a coating is shown in FIG. 1, and is designated generally throughout by the reference numeral 10.

Referring to FIG. 1, the optical fiber 10 includes a glass core 12, a cladding layer 14 surrounding and adjacent to the glass core 12, an inner primary coating material 16 which adheres to the cladding layer 14, and one or more outer primary coating materials 18 surrounding and adjacent to the primary coating material 16.

Any conventional material can be used to form the glass core 12, such as those described in U.S. Pat. No. 4,486,212 to Berkey, which is hereby incorporated by reference. The core is typically a silica glass having a cylindrical cross section and a diameter ranging from about 5 to about 10 μm for single-mode fibers and about 20 to about 100 μm for multi-mode fibers. The core can optionally contain varying amounts of other material such as, e.g., oxides of titanium, thallium, germanium, and boron, which modify the core's refractive index. Other dopants which are known in the art can also be added to the glass core to modify its properties. Optionally fiber 10 may have one or more concentric core regions (not shown).

The cladding layer 14 preferably has a refractive index which is less than the refractive index of the core. A variety of cladding materials, both plastic and glass (e.g., silicate and borosilicate glasses) are used in constructing conventional glass fibers. Any conventional cladding materials known in the art can be used to form the cladding layer 14 in the optical fiber of the present invention.

In FIG. 1, cladding 14 is surrounded by an inner primary coating 16 (also known simply as a primary coating). Coating material 16 is the polymerization product of any suitable inner primary coating composition. A number of suitable inner primary coating compositions are known in the art and others are continually being developed. Typically, inner primary coating compositions contain a high concentration of one or more oligomeric components (e.g., polyether urethane acrylate oligomers, polyester urethane acrylate oligomers, polyurea urethane acrylate oligomers, polyether acrylate oligomers, polyester acrylate oligomers, polyurea acrylate oligomers, epoxy acrylate oligomer, and hydrogenated polybutadiene oligomers), one or more monomeric components as reactive diluents or cross-linking agents, adhesion promoters which promote adhesion of the primary coating to the underlying glass fiber, polymerization initiators, and other known additives. For additional information regarding primary coatings the following U.S. patents and applications the specifications of which are hereby incorporated by reference in their entirety: U.S. Pat. No. 6,316,516; U.S. Pat. No. 6,326,416; U.S. Ser. No. 10/056,940; U.S. Ser. No. 09/712,565; and U.S. Ser. No. 09/712,603.

In FIG. 1, inner primary coating 16 is surrounded by an outer primary coating 18 (also known as a secondary coating). Outer primary coating material 18 is typically the polymerization (i.e., cured) product of a coating composition that contains urethane acrylate liquids whose molecules become cross-linked when polymerized. Other suitable materials for use in outer primary coating materials, as well as considerations related to selection of these materials, are described in U.S. Pat. Nos. 4,962,992 and 5,104,433 to Chapin, the specifications of which are hereby incorporated by reference. Various additives that enhance one or more properties of the coating can also be present.

Preferably outer primary coating 18 will be the polymerization product of a coating composition including at least one substantially exfoliated clay, and optionally at least one UV curable monomer and at least one photoinitiator. The coating composition used to form coating 18 may also include about 0-55 weight percent of at least one UV curable oligomer. It is preferred that coating 18 is not a thermoplastic resin. Preferably, both the monomer and the oligomer are compounds capable of participating in addition polymerization. The monomer or the oligomer may be the major component of the coating composition used to form coating 18. An example of a suitable monomer is an ethylenically unsaturated monomer. Ethylenically unsaturated monomers may contain various functional groups, which enable their cross-linking. The ethylenically unsaturated monomers are preferably polyfunctional (i.e., each containing two or more functional groups), although monofunctional monomers can also be introduced into the composition. Therefore, the ethylenically unsaturated monomer can be a polyfunctional monomer, a monofunctional monomer, and mixtures thereof. Suitable functional groups for ethylenically unsaturated monomers used in accordance with the present invention include, without limitation, acrylates, methacrylates, acrylamides, N-vinyl amides, styrenes, vinyl ethers, vinyl esters, acid esters, and combinations thereof (i.e., for polyfunctional monomers).

In general, individual monomers capable of a degree of cure of about 80% or more are more desirable than those having a lower degree of cure. Degree of cure may be defined as the ratio of double bonds that react during the curing process to the total number of double bonds in the formulation. For example if the formulation starts out with 100 double bonds and after cure 80 of the double bonds are reacted, the degree of cure is 80%. The degree to which monomers having lower conversion rates can be introduced into the composition depends upon the particular requirements (i.e., strength) of the resulting cured product. Typically, higher conversion rates will yield stronger cured products.

Suitable polyfunctional ethylenically unsaturated monomers include, without limitation, alkoxylated bisphenol A diacrylates such as ethoxylated bisphenol A diacrylate with ethoxylation being 2 or greater, preferably ranging from 2 to about 30, e.g. SR349 and SR601 available from Sartomer Company, Inc. (West Chester, Pa.); Photomer 4025 and Photomer 4028, available from Cognis Corp. (Ambler, Pa.); propoxylated bisphenol A diacrylate with propoxylation being 2 or greater, preferably ranging from 2 to about 30; methylolpropane polyacrylates with and without alkoxylation such as ethoxylated trimethylolpropane triacrylate with ethoxylation being 3 or greater, preferably ranging from 3 to about 30 (e.g., Photomer 4149, Cognis Corp., and SR499, Sartomer Company, Inc.); propoxylated trimethylolpropane triacrylate with propoxylation being 3 or greater, preferably ranging from 3 to 30 (e.g., Photomer 4072, Cognis Corp. and SR492, Sartomer); ditrimethylolpropane tetraacrylate (e.g., Photomer 4355, Cognis Corp.); alkoxylated glyceryl triacrylates such as propoxylated glyceryl triacrylate with propoxylation being 3 or greater (e.g., Photomer 4096, Cognis Corp. and SR9020, Sartomer); erythritol polyacrylates with and without alkoxylation, such as pentaerythritol tetraacrylate (e.g., SR295, available from Sartomer Company, Inc. (West Chester, Pa.); ethoxylated pentaerythritol tetraacrylate (e.g., SR494, Sartomer Company, Inc.); dipentaerythritol pentaacrylate (e.g., Photomer 4399, Cognis Corp., and SR399, Sartomer Company, Inc.); isocyanurate polyacrylates formed by reacting an appropriate functional isocyanurate with an acrylic acid or acryloyl chloride, such as tris-(2-hydroxyethyl) isocyanurate triacrylate (e.g., SR368, Sartomer Company, Inc.) and tris-(2-hydroxyethyl) isocyanurate diacrylate; alcohol polyacrylates with and without alkoxylation such as tricyclodecane dimethanol diacrylate (e.g., CD406, Sartomer Company, Inc.); ethoxylated polyethylene glycol diacrylate with ethoxylation being 2 or greater, preferably ranging from about 2 to 30; epoxy acrylates formed by adding acrylate to bisphenol A diglycidylether and the like (e.g., Photomer 3016, Cognis Corp.); and single and multi-ring cyclic aromatic or non-aromatic polyacrylates such as dicyclopentadiene diacrylate and dicyclopentane diacrylate.

It may also be desirable to use certain amounts of monofunctional ethylenically unsaturated monomers, which can be introduced to influence the degree to which the cured product absorbs water, adheres to other coating materials, or behaves under stress. Exemplary monofunctional ethylenically unsaturated monomers include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate, 2-ethylhexyl acrylate, nonyl acrylate, decyl acrylate, isodecyl acrylate, undecyl acrylate, dodecyl acrylate, lauryl acrylate, octadecyl acrylate, and stearyl acrylate; aminoalkyl acrylates such as dimethylaminoethyl acrylate, diethylaminoethyl acrylate, and 7-amino-3,7-dimethyloctyl acrylate; alkoxyalkyl acrylates such as butoxylethyl acrylate, phenoxyethyl acrylate (e.g., SR339, Sartomer Company, Inc.), and ethoxyethoxyethyl acrylate; single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bomyl acrylate, isobornyl acrylate (e.g., SR423, Sartomer Company, Inc.), tetrahydrofurfuryl acrylate (e.g., SR285, Sartomer Company, Inc.), caprolactone acrylate (e.g., SR495, Sartomer Company, Inc.), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated(4) nonylphenol acrylate (e.g., Photomer 4003, Cognis Corp.); acrylamides such as diacetone acrylamide, isobutoxymethyl acrylamide, N,N′-dimethyl-aminopropyl acrylamide, N,N-dimethyl acrylamide, N,N-diethyl acrylamide, and t-octyl acrylamide; vinylic compounds such as N-vinylpyrrolidone and N-vinylcaprolactam; and acid esters such as maleic acid ester and fumaric acid ester.

Most suitable monomers are either commercially available or readily synthesized using reaction schemes known in the art. For example, most of the above-listed monofunctional monomers can be synthesized by reacting an appropriate alcohol or amine with an acrylic acid or acryloyl chloride.

Preferably the substantially exfoliated clay of coating 18 may comprise any swellable layered clay (the clay may also be known as a silicate) where the individual layers are negatively charged and balanced by ion-exchangeable alkali or alkali earth metal cations. The clay can be either natural or synthetic layered silicate including, but not limited to, montmorillonite (Mt), hectorite, fluorohectorite, fluromica, and vermiculite. The preferred cation exchange capacity (CEC) of the layered silicate ranges from at least about 40 meq/100 g, and more preferably at least about 45 meq/100 g, up to about 245 meq/100 g, and more preferably up to about 240 meq/100 g. If the CEC is less than about 40 meq/100 g, substantial dispersion of the clay after modification with organic moiety in the resin can be difficult to achieve. If the CEC is more than about 250 meq/100 g, the bond between adjacent layers of the clay may be so firm that the clay is difficult to disperse into coating composition used to form coating 18.

Preferably an organic substance may be used to modify the clay. Preferred organic substances are positively charged, or are substances that can be turned into positively charged substances. The modification of the clay may occur, for example, by exchange of the exchangeable cations of the clay (e.g. Na⁺) for positively charged organic species. Some of these substances may be known in the art as surfactants. Such substances include, but are not limited to, primary, secondary, tertiary alkyl amines with the general formula: (1) RNH₂, where R>C₈; (2) R₁R₂NH, where R₁ or/and R₂>C₈; and (3) R₁R₂R₃N, where at least one of R₁, R₂ and R₃ is >C₈.

One source of organic substances is Akzo Nobel of Arnhern, Netherlands. Examples of primary amines which are suitable organic substances include dodecylamine, hexadecylamine, octadecylamine, cocoalkylamines, hydrogenated rapeseedalkylamines, C₁₆-C₁₈ hydrogenated tallowalkylamines, oleylamine, rapeseedalkylamines, C₁₆-C₁₈ soyaalkylamines, and C₁₆-C₁₈ tallowalkylamines.

Examples of secondary amines which are suitable organic substances include dicocoalkylamines, and C₁₆-C₁₈ di(hydrogenated tallowalkyl)amines. Examples of tertiary amines which are suitable organic substances include tridodecylamine, trihexadecylamine, dodecyldimethylamine, octadecyldimethylamine, C₁₆-C₁₈ hydrogenated tallowalkyldimethylamines, oleyldimethylamine, soyaalkyldimethylamines, tallowalkyldimethylamines, and hexadecyldimethylamine.

Examples of polyamines which are suitable organic substances include N-cocoalkyl-1,3-diaminopropane, C₁₈ N-oleyl-1,3-diaminopropane, C₁₆-C₁₈ N-soyaalkyl-1,3-di aminopropane, C₁₆-C₁₈ N-tallowalkyl-1,3-diaminopropane, C₁₆-C₁₈ N-tallowalkyl tripropylene tetramines, and C₁₆-C₁₈ N-tallowalkyl dipropylene triamines.

Examples of ethoxylated amines which are suitable organic substances include C₁₈ bis(2-hydroxyethyl)octadecylamine, C₁₈ polyoxyethylene (5) octadecylamine, C₁₈ polyoxyethylene (15) octadecylamine, C₁₈ polyoxyethylene (50) octadecylamine, bis(2-hydroxyethyl)cocoalkylamines, polyoxyethylene (5) cocoalkylamines, polyoxyethylene (15) cocoalkylamines, C₁₈ bis(2-hydroxyethyl)oleylamine, C₁₈ polyoxyethylene (5) oleylamine, C₁₆-C₁₈ bis(2-hydroxylethyl)soyaalkylamines, C₁₆-C₁₈ polyoxyethylene (5) soyaalkylamines, C₁₆-C₁₈ polyoxyethylene (15) soyaalkylamines, C₁₆-C₁₈ bis (2-hydroxyethyl) tallowalkylamines, C₁₆-C₁₈ polyoxyethylene (5) tallowalkylamines, C₁₆-C₁₈ polyoxyethylene (15) tallowalkylamines, C₁₈ N-oleyl-1,1′-iminobis-2-propanol, C₁₆-C₁₈ N-tallowalkyl-1,1′-iminobis-2-propanol, C₁₆-C₁₈ tris(2-hydroxyethyl)-N-tallowalkyl-1,3-diaminopropane, C₁₆-C₁₈ tris(2-hydroxyethyl)-N-tallowalkyl-1,3-diaminopropane, C₁₆-C₁₈ polyoxyethylene (10) N-tallowalkyl-1,3-diaminopropane and C₁₆-C₁₈ polyoxyethylene (15) N-tallowalkyl-1,3-diaminopropane.

Other suitable organic substances include aromatic and heteroaromatic amines such as substituted pyridines and anilines. As the skilled artisan will appreciate, ammonium salt analogs of a suitable amine will also be suitable for organic modification of the clay.

Quaternary ammonium salts are also preferred substances for organic modification of clays. Examples of quaternary ammonium salts which are suitable organic substances include dodecyltrimethyl ammonium chloride, hexadecyltrimethyl ammonium chloride, octadecyltrimethyl ammonium chloride, dicocoalkyldimethyl ammonium chloride C₁₆-C₁₈ di(hydrogenated tallowalkyl)dimethyl ammonium chloride hydrogenated tallowalkyl(2-ethylhexyl)dimethyl ammonium methylsulfate, trihexadecylmethyl ammonium chloride, cocoalkyltrimethyl ammonium chloride, benzyldimethylcocoalkyl ammonium chloride, C₁₆-C₁₈ benzyldimethyl(hydrogenated tallowalkyl) ammonium chloride, benzylmethyldi(hydrogenated tallowalkyl) ammonium chloride, C₁₆-C₁₈ soyaalkyltrimethyl ammonium chloride, C₁₆-C₁₈ tallowalkyltrimethyl ammonium chloride, C₁₆-C₁₈ pentamethyltallowalkyl-1,3-propane diammonium dichloride, C₁₈ octadecylmethylbis(2-hydroxyethyl) ammonium chloride, C₁₈ octadecylmethyl[polyoxyethylene (15) ammonium chloride, cocoalkylmethylbis(2-hydroxyethyl) ammonium chloride, cocoalkylmethylbis(2-hydroxyethyl) ammonium nitrate, benzylbis(2-hydroxyethyl)cocoalkyl ammonium chloride, cocoalkylmethyl[polyoxyethylene (15) ammonium chloride, C₁₈ Oleylmethylbis(2-hydroxyethyl) ammonium chloride, and C₁₆-C₁₈ tris(2-hydroxyethyl)tallowalkyl ammonium acetate. Alkylpyridinium salts of halides, sulfates, nitrates, or methylsulfates are also suitable organic substances. Preferably the alkyl group comprises 8 or more carbon groups and the halides are either chloride or bromide.

Other organic cations may be used to modify the clay. For example, phosphonium or sulfonium salts may be suitable compounds for use in the present invention. Preferably, a phosphonium or sulfonium salt will include a long alkyl chain. For example, the phosphonium or sulfonium salt may have a structure analogous to one of the quaternary ammonium salts described above.

Ether amines or ether ammonium salts with the below general formula may also be suitable organic substances: (1) ROCH₂CH₂CH₂NH₂, (2) ROCH₂CH₂CH₂NHR′, (3) ROCH₂CH₂CH₂NR′R″, and (4) ROCH2CH2CH2N⁺R′R″CH3. In each molecule, at least one of R, R′ or R″ preferably includes one alkyl group having at least about eight carbon atoms. Ethoxylated amines/salts with the below general formula may also be suitable organic substances: (1) ROCH₂CH₂CH₂N(CH₂CH₂O)ₓ(CH₂CH₂O)ₙ₋ₓ and (2) ROCH₂CH₂CH₂NCH₃(CH₂CH₂O)ₙ₋ₓH(CH₂H₂O)ₙ₋ₓH. In the above formulas (1) and (2) “n” comprises about 15 or less and “x” comprises about 14 or less. Examples of the aforementioned organic substances manufactured by Tamoh Products, Inc., of Millton, Wis.

Other suitable organic substances include such compounds as ε-caprolactam or aminoacids having the general formula of H₂NRCOOH, wherein R is preferably a moiety with about eight (8) or more carbon atoms. Additional suitable organic substances include reactive surfactants such as: N-dodecyl-4-ethenyl-N, N-dimethylbenzenemethanaminuim chloride, and [3-(acryloyl)propyl]dodecyldimethylammonium chloride.

The modification of the clay with an organic substance yields an organoclay. The organoclay may be prepared by combining the clay with the organic substance in a medium. Mediums from which the organoclay of the present invention may be made include, for example, water and a mixture of water and a water-miscible solvent such as ethyl alcohol. In one embodiment, the solvent may be fully miscible in the water, meaning no noticeable phase separation between the water and the solvent is observable. In the case of amines, including ε-caprolactam or aminoacids, equivalent amounts of a mineral acid is added to protonate the amino group. Positively charged organic species such as ammonium salts may be directly dissolved in the above-mentioned mediums of water or water and the solvent. The amount of the organic substance used for ion exchange depends on the CEC of the layered silicate. In forming the organoclay, the ratio of equivalents of the positive charges in the organic substance to exchangeable positive charges in the clay is preferably from about 0.75 to about 6.0, more preferably from about 0.8 to about 5.0, even more preferably from about 1.0 to about 3.0, and most preferably from about 1.2 to about 2.0. If the ratio is below about 0.7, the degree of ion exchange may be low and the clay may not disperse well enough for the aforementioned applications. If the ratio is more than 6.0, the excess organic substance and residual inorganic cations may be difficult to remove, which may adversely affect the performance of coating 18. Preferably, the degree of ion exchange can be improved by a second ion exchange. The organoclay is washed with deionized water at least three times until it is halide-free in the case of surfactant organic substances containing halides as negative balancing charges. At this point the clay has been modified into an organoclay.

Preferably the organoclay used in the present invention has a basal spacing d₀₀₁ of at least about 14 Angstroms, more preferably at least about 16 Angstroms as determined by X-ray diffraction. Coating 18 may also be prepared based on the procedure described in the examples below.

In some instances the surface of the organoclay has at least one or more of the following reactive groups: acrylate, methacrylate, styrene, epoxy, vinyl and combinations thereof. For example, [3-(acryloyl)propyl]dodecyldimethylammonium chloride inlcudes a reactive acrylate group.

In the composition of coating 18 of the invention, the amount of the substantially exfoliated organoclay is preferably about 0.1 to about 20 percent by weight, more preferably about 0.5 to about 10 percent by weight, most preferably about 2 to about 6 percent by weight. If the organoclay is less than about 0.1 percent by weight, the reinforcing effect to the radiation curable resin matrix is insubstantial for obtaining a nanocomposite composition for coating 18 having desired enhanced physico-mechanical properties. If the concentration is more than about 25 percent by weight, the transparency of coating 18 is compromised, due to the poor dispersion of the clay in coating composition 18. Further, the elongation properties of the cured coating 18 may deteriorate.

Preferred clay minerals for the present invention have unique structures. For example, montmorrilonite (Mt), a naturally occurring smectite, has excellent swelling behavior, ideal ion exchange capacity (CEC), and a large layer aspect ratio. Each individual layer (platelet) of Mt clay is composed of a mixture of [AlO6] and [MgO₆] octahedral sublayer sandwiched between two [SiO₄] tetrahedral sublayers (the so-called 2:1 layered silicate family). The two tetrahedral sublayers are usually electrically neutral due to the two oxygen atoms saturating each Si atom on average, resulting in the platelets being attracted by van der Waals forces. Such bonds can be broken by a shear force. The octahedral sublayer, on the other hand, is negatively charged due to the partial replacement of trivalent Al with divalent Mg. In order to maintain the electrical neutrality, external cations are needed. These cations are thus exchangeable with any guest cations in the organic substances (preferably a surfactant). The average distance between the two adjacent platelets of the clay is about 0.4 nm and may vary with the amount of hydrating water. The cation exchange capacity of the layered silicate depends on the degree of substitution in the octahedral sublayer. The platelets of Mt clay are only 1 nm in thickness and up to about one micron or more in length and width, giving each platelet a very high aspect ratio. Pristine clays are hydrophilic; however, if the inorganic ions are replaced by organic ionic surfactants, the clay becomes swelled and hydrophobic. The intragallery distance (i.e. the distance between individual clay platelets) can go up to at least about 13 Ångstroms. Preferably, the intragallery distance of the organoclay before dispersal in the coating comprises not more than about 80 Ångstroms.

The organoclays obtained are much more compatible with organic monomers, oligomers, or polymers than their fully inorganic counterparts. As a result, these organic species (monomers, oligomers, and polymers) can diffuse into the clay intragallery, causing the organoclay to swell further. In other words, individual clay platelets can be separated by organic species. A resin which comprises the aforementioned clay dispersed into above organic species (monomers, oligomers, and polymers) is a “nanocomposite”. Additional swelling can occur by the insertion of any organic species into the organoclay. Preferably, the nanocomposite coating resin comprises a radiation curable resin, into which an organically modified layered clay is well dispersed on a molecular level. The phrase “on a molecular level” is used herein to mean that the clay is substantially exfoliated. As used herein, “substantially exfoliated” means that the basal spacing of the intercalated clay, d₀₀₁, as determined by X-ray diffraction, comprises at least about 20 Ångstroms or more on average, more preferably about 30 Ångstroms, and that the clay intragallery is substantially filled with organic species.

The organically modified clays of the invention should yield after optimal dispersion process into a coating resin (organic spieces), clay particle sizes as defined below. The size of individual particles is defined by their long and short dimensions as seen from the image of transmission electron microscopy. The long and short dimensions of the particles dispersed in the resin in the present invention are in the range of about 0.1 to about 5 μm and about 0.001 to about 0.5 μm, respectively. Preferably, substantially all of the individual clay particles have a long dimension less than about 2 μm in length, and more preferably less than about 1 μm in length. The aspect ratio, defined as the ratio of the long dimension to the short dimension is in the range of about 5 to about 5000. If the basal spacing of the intercalated clay is less than about 20 Ångstroms, the size of the clay particles will most likely not yield the dimensions specified above. If the size of the particles exceeds the above dimension in the coating resin, the coated fiber may lose mechanical strength, and its attenuation losses may increase in standard microbend tests (expandable drum, basketweave, lateral load wire mesh, and the rack test).

Preferably, the exfoliated clay may comprises a fully exfoliated clay. The clay is fully exfoliated when a low angle x-ray diffraction of the clay does not substantially exhibit any peaks between an angle of at least about 6° up to and including about 8°, more preferably between an angle of at least about 1° up to and including about 10°.

As indicated above, an optional constituent of coating composition used to form coating 18 is the oligomeric component. If the oligomeric component is included in the coating composition, preferably the concentration of the oligomeric component is no more than about 55 weight %, more preferably less than about 40 weight %, even more preferably less than about 15 weight %, and most preferably less than about 5 weight %. One advantage of maintaining the concentration of the oligomeric component in the coating composition used to form coating 18 to about 55 weight % or less is the uncured coating composition viscosity should remain at processable levels. Uncured coating composition with an oligomeric component of more than about 55 weight % typically have too high a viscosity to be consistently applied to fiber during drawing. This is especially true at higher draws speeds such as more than about 20 m/s. To enable effective optical fiber and fiber optic ribbon production, the coating composition of the present invention should be sufficiently viscous at processing temperatures so that it remains on the coated glass fibers until it is cured. A suitable viscosity for the coating composition of the present invention is between about 250 and about 2500 centipoise at 45° C., preferably between about 300 and about 2000 centipoise at 45° C., more preferably between about 350 and about 1500 centipoise at 45° C. With respect to viscosity and the individual components of the coating compositin, the monomers may be referred to as the low viscosity component and the oligomeric component may be referred to as the high viscosity component.

The oligomeric component can include a single oligomer or it can be a combination of two or more oligomers. When employed, if at all, the oligomeric component introduced into the compositions of the present invention preferably comprises ethylenically unsaturated oligomers.

When employed, suitable oligomers can be either monofunctional oligomers or polyfunctional oligomers, although polyfunctional oligomers are preferred. The oligomeric component can also be a combination of a monofunctional oligomer and a polyfunctional oligomer.

Di-functional oligomers preferably have a structure according to formula (I) below:

F₁-R₁-[Diisocyanate-R₂-]ₘDiisocyanate-R₁-F₁ (I)

where F₁ is independently a reactive functional group such as acrylate, methacrylate, acrylamide, N-vinyl amide, styrene, vinyl ether, vinyl ester, or other functional group known in the art; R₁ includes independently —C₂₋₁₂O—, —(C₂₋₄—O)ₙ—, —C₂₋₁₂O—(C₂₋₄—O)ₙ—, —C₂₋₁₂O—(CO—C₂₋₅O)ₙ—, or —C₂₋₁₂O—(CO—C₂₋₅NH)ₙ— where n is a whole number from 1 to 30, preferably 1 to 10; R₂ is polyether, polyester, polycarbonate, polyamide, polyurethane, polyurea, or combinations thereof; and m is a whole number from 1 to 10, preferably 1 to 5. In the structure of formula I, the diisocyanate group is the reaction product formed following bonding of a diisocyanate to R₂ and/or R₁.

Other polyfunctional oligomers preferably have a structure according to formula (II) or formula (III) as set forth below:

multiisocyanate-(R₂-R₁-F₂)ₓ (II)

or

polyol-[(diisocyanate-R₂)ₘ-diisocyanate -R₁-F₂]ₓ (III)

where F₂ independently represents from 1 to 3 functional groups such as acrylate, methacrylate, acrylamide, N-vinyl amide, styrene, vinyl ether, vinyl ester, or other functional groups known in the art; R₁ can include —C₂₋₁₂O—, —(C₂₋₄—O)ₙ—, —C₂₋₁₂O—(C₂₋₄—O)ₙ—, —C₂₋₁₂O—(CO—C₂₋₅O)ₙ—, or —C₂₋₁₂O—(CO—C₂₋₅NH)ₙ— where n is a whole number from 1 to 10, preferably 1 to 5; R₂ can be polyether, polyester, polycarbonate, polyamide, polyurethane, polyurea or combinations thereof; x is a whole number from 1 to 10, preferably 2 to 5; and m is a whole number from 1 to 10, preferably 1 to 5. In the structure of formula II, the multiisocyanate group is the reaction product formed following bonding of a multiisocyanate to R₂. Similarly, the diisocyanate group in the structure of formula III is the reaction product formed following bonding of a diisocyanate to R₂ and/or R₁.

Urethane oligomers are conventionally provided by reacting an aliphatic diisocyanate with a dihydric polyether or polyester, most typically a polyoxyalkylene glycol such as a polyethylene glycol. Such oligomers typically have between about four to about ten urethane groups and may be of high molecular weight, e.g., 2000-8000. However, lower molecular weight oligomers, having molecular weights in the 500-2000 range, may also be used. U.S. Pat. No. 4,608,409 to Coady et al. and U.S. Pat. No. 4,609,718 to Bishop et al., the specifications of which are hereby incorporated by reference to describe such syntheses in detail.

When it is desirable to employ moisture-resistant oligomers, they may be synthesized in an analogous manner, except that the polar polyether or polyester glycols are avoided in favor of predominantly saturated and predominantly nonpolar aliphatic diols. These diols include, for example, alkane or alkylene diols of from about 2-250 carbon atoms and, preferably, are substantially free of ether or ester groups.

Polyurea components may be incorporated in oligomers prepared by these methods, simply by substituting diamines or polyamines for diols or polyols in the course of synthesis. The presence of minor proportions of polyurea components in the present coating systems is not considered detrimental to coating performance, provided only that the diamines or polyamines employed in the synthesis are sufficiently non-polar and saturated as to avoid compromising the moisture resistance of the system.

Suitable oligomers include BR301, an aromatic urethane acrylate oligomer available from Bomar Specialty Co.; Photomer 6010, an aliphatic urethane acrylate oligomer available from Henkel Corp.; KWS5021, an aliphatic urethane acrylate oligomer available from Bomar Specialty Co.; RCC12-892, a multi-functional aliphatic urethane acrylate oligomer available from Henkel Corp.; RCC13-572, an aromatic urethane diacrylate oligomer available from Henkel Corp.; and KWS4131, an aliphatic urethane acrylate oligomer available from Bomar Specialty Co.

Optical fiber outer primary coating compositions may also contain a polymerization initiator which is suitable to cause polymerization (i.e., curing) of the composition after its application to a glass fiber or previously coated glass fiber. Polymerization initiators suitable for use in the compositions of the present invention include thermal initiators, chemical initiators, electron beam initiators, microwave initiators, actinic-radiation initiators, cationic initiators, free radical initiators, and photoinitiators. Particularly preferred are the photoinitiators. For most acrylate-based coating formulations, conventional photoinitiators, such as the known ketonic photoinitiating and/or phosphine oxide additives, are preferred. When used in the compositions of the present invention, the photoinitiator is present in an amount sufficient to provide rapid ultraviolet curing. Generally, this includes about 0.5 to about 10.0 weight percent, more preferably about 1.5 to about 7.5 weight percent.

The photoinitiator, when used in a small but effective amount to promote radiation cure, must provide reasonable cure speed without causing premature gelation of the coating composition. A desirable cure speed is any speed sufficient to cause substantial curing (i.e., greater than about 90%, more preferably 95%) of the coating composition. As measured in a dose versus modulus curve, a cure speed for coating thicknesses of about 25-35 μm is, e.g., less than 1.0 J/cm², preferably less than 0.5 J/cm².

Suitable photoinitiators include, without limitation, 1-hydroxycyclohexylphenyl ketone (e.g., Irgacure 184 available from Ciba Specialty Chemical (Tarrytown, N.Y.)), (2,6-dimethoxybenzoyl)-2,4,4-trimethylpentyl phosphine oxide (e.g., in commercial blends Irgacure 1800, 1850, and 1700, Ciba Specialty Chemical), 2,2-dimethoxyl-2-phenyl acetophenone (e.g., Irgacure 651, Ciba Specialty Chemical), bis(2,4,6-trimethylbenzoyl)phenyl phosphine oxide (e.g., Irgacure 819, Ciba Specialty Chemical), (2,4,6-trimethylbenzoyl)diphenyl phosphine oxide (e.g., in commercial blend Darocur 4265, Ciba Specialty Chemical), 2-hydroxy-2-methyl-1-phenylpropane-1-one (e.g., in commercial blend Darocur 4265, Ciba Specialty Chemical) and combinations thereof. Other photoinitiators are continually being developed and used in coating compositions on glass fibers. Any suitable photoinitiator can be introduced into compositions of the present invention.

In addition to the above-described components, the outer primary coating composition of the present invention can optionally include an additive or a combination of additives. Suitable additives include, without limitation, antioxidants, catalysts, lubricants, low molecular weight non-crosslinking resins, adhesion promoters, and stabilizers. Some additives can operate to control the polymerization process, thereby affecting the physical properties (e.g., modulus, glass transition temperature) of the polymerization product formed from the composition. Others can affect the integrity of the polymerization product of the composition (e.g., protect against de-polymerization or oxidative degradation).

A preferred antioxidant is thiodiethylene bis(3,5-di-tert-butyl)-4-hydroxyhydrocinnamate (e.g., Irganox 1035, available from Ciba Specialty Chemical).

Other suitable materials for use in outer primary coating materials, as well as considerations related to selection of these materials are described in U.S. Pat. Nos. 4,962,992 and 5,104,433 to Chapin, which are hereby incorporated by reference. Various additives that enhance one or more properties of the coating can also be present, including the above-mentioned additives incorporated in the compositions of the present invention.

As used herein, the weight percent of a particular component refers to the amount introduced into the bulk composition excluding the adhesion promoter and other additives. The amount of adhesion promoter and various other additives that are introduced into the bulk composition to produce a composition of the present invention is listed in parts per hundred. For example, an oligomer, monomer, clay, and photoinitiator are combined to form the bulk composition such that the total weight percent of these components equals 100 percent. To this bulk composition, an amount of adhesion promoter, for example 1.0 part per hundred, is introduced in excess of the 100 weight percent of the bulk composition.

Reference is made to U.S. Patent Application No. 60/173,874, filed Dec. 30, 1999, and Provisional U.S. Patent Application filed Jul. 26, 2000 by Botelho et al., titled Secondary Coating Compositions for Optical Fibers, the specifications of which are incorporated herein by reference as though fully set forth in its entirety, for a more detailed explanation of outer primary coatings.

Preferably, outer primary coating 18 has a Young's modulus of at least about 100 MPa, more preferably at least about 500 MPa, and most preferably at least about 1000 MPa. In one embodiment of fiber 10, the outer diameter of outer primary coating 18 is about 245 μm±5 μm.

Outer primary coating 18 can be a tight buffer coating or, alternatively, a loose tube coating. Irrespective of the type of outer primary coating employed, it is preferred that the outer surface of outer primary coating 18 is not tacky so that adjacent convolutions of the fiber (i.e., on a process spool) can be unwound.

In accordance with the invention, another aspect of the invention is an optical fiber coating composition. The composition includes a UV curable formulation which comprises no more than about 55 weight percent of an acrylate oligomer and a substantially exfoliated clay. Preferably, the composition when cured has a Young's modulus of at least about 100 MPa at room temperature. More preferably the Young's modulus comprises at least about 700 MPa, even more preferably at least about 800 MPa, and most preferably at least about 900 MPa. Optionally, the composition may comprise a free radical cure system or a cationic cure system. Alternatively, the composition may also be hydrophobic. Furthermore, the composition may be substantially devoid of an acrylate oligomer.

It is preferred that the outer primary coating composition contains about 10-90% of the monomer; of about 0-55% of the oligomer; 0.1-25% of the substantially exfoliated clay and about 0.5-10% of the photoinitiator. The composition may include an epoxy acrylate component. Preferably, the composition comprises no more than about 10% of the epoxy acrylate component. An example of a suitable epoxy acrylate material is PH 3016 available from Cognis of Ambler, Pa. The composition may include at least one bisphenol acrylate functional component. The bisphenol acrylate functional component may be a monomer or an oligomer. Examples of a preferred a bisphenol acrylate functional component comprises PH 4025 and PH 4028 available from Cognis. Optionally, the composition may also include at least one hydroxyl functional monomer.

With respect to major components of the composition such as oligomers, monomers, and the clay, preferably the composition comprises less than about 40% of an acrylate functional oligomer, more preferably less than about 15% oligomer, even more preferably less than 10% oligomer, and most preferably less than about 5% oligomer. In one embodiment, the composition is substantially devoid of oligomer. Substantially devoid of oligomer is here defined to mean a composition having an oligomer content of less than about 4% to devoid (0%) of oligomer.

With respect to monomers, preferably, the composition comprises at least about 20% monomer, more preferably at least about 40%, and most preferably at least about 50%. The monomer component of the composition may consists of one or more monomers, e.g., about two monomers or more. A preferred type of monomer comprises an acrylate functional monomer. The monomer may be mono or multi acrylate functional. Preferred types of multi functional acrylates comprises di, tri, or tetra functional acrylates. Also, the mono and multi functional acrylate monomers may be used in combination in a specific embodiment of the inventive composition.

Preferably, the composition comprises up to about up to about 25 weight percent of the clay. More preferably, the composition comprises up to about 20% of the clay, even more preferably about 0.5% to about 10% of the clay, and most preferably about 3% to about 6% of the clay.

Another aspect of the invention will include a coated optical fiber. Preferably, the optical fiber has at least one core segment and at least one cladding region. Preferably the cladding region comprises at least one glass region of refractive index lower than a refractive index of the core segment with the highest refractive index. It is also preferred that the optical fiber is coated at least one embodiment of the aforementioned coating composition.

Preferably, the fiber has an effective area of greater than about 60 μm² at a wavelength of 1550 nm, more preferably at least about 70 μm², even more preferably at least about 80 μm, and most preferably at least about 90 μm². The effective area A_{eff}=2π (∫E² r dr)²/(∫E⁴ r dr), where the integration limits are 0 to ∞ and E is the electric field associated with light propagated in the waveguide.

Optical fiber microbend loss (as well as macrobend loss of single mode fibers) is strongly dependent of Δβ, the difference in propagation constants between the fundamental (guided) mode, and the next lowest order mode (usually a cladding mode). In fact, much of the developed microbending theory hypothesizes that microbending loss is proportional to (Δβ)⁻⁶, meaning that smaller Δβ values will result in much higher microbending losses. Therefore, Δβ is a primary indicator of the sensitivity of a given fiber profile design to microbending (as well as macrobending) loss. The inventive coating has an excellent application as a coating for a fiber with a Δβ of about 7/mm or less over a wavelength range of about 1200 nm to about 1700 nm, more preferably less than about 5/mm or less, even more preferably about 3/mm or less, and most preferably about 1.5/mm or less. The Δβ comes directly from the solution of the wave equation for the modes of the waveguide. β is the modal propogation constant obtained from the wave equation after the boundary conditions are completely specified. Each mode solution of the wave equation will have a unique β (excluding the degeneracies for polarization, etc.). In fact, the β for a mode is the eigenvalue of the wave equation for that mode (β=2π/λ×n_{eff}), and Δβ is just the difference of the β of the two modes. A waveguide will have a complete, orthoganol set of solutions, or modes that will satisfy the wave equation within the boundary conditions of the waveguide (size, index profile). These solutions can be found in many ways, one method is to numerically integrate the wave equation using an initial guess for the β of the mode (n_{eff} must be between the core and cladding indices, for example). If the solution converges (the field doesn't go to infinity at infinite distance), the guess for β must have been correct; if not, then the guess for β is adjusted until the solution does converge.

The optical fiber may also have an inner primary (A.K.A primary) coating adjacent to cladding 14 and coating 18. Preferably, the inner primary coating has a Young's modulus, at room temperature, of less than about 2.0 MPa, more preferably less than about 1.5 MPa, and even more preferably no more than about 1.25 MPa, and most preferably no more than about 1.0 MPa. In one embodiment of fiber 10, preferably coating 16 has a Young's modulus of less than about 2.0 MPa and coating 18 has a Young's modulus of about 800 MPa or higher.

As embodied herein an aspect of the invention also includes a method of making the inventive optical fiber coating composition. The method includes the step of dispersing an organoclay into a low viscosity mixture forming a nanocomposite. One technique of dispersing the organoclay into the mixture includes mechanically blending the organoclay with the low viscosity mixture. Preferably the low viscosity mixture has a viscosity of about 1000 centiPoise or less at room temperature. Preferably the low viscosity mixture flows easily. Typically, the low viscosity mixture comprises at least one or more monomers that are to be included in the coating composition, preferably all of the monomers in the composition. The low viscosity mixture may also include any additives and photoinitiator that is desired to be part of the composition. The method further includes milling the nanocomposite forming a mill and collecting the mill. An example of the milling step includes passing the nanocomposite through an agitated chamber with a contacting media. The media will come in contact with the particles of clay in the nanocomposite and reduce the size of the clay particles. One advantage of milling the nanocomposite is that the milling will reduce the viscosity of the nanocomposite. Typically the milling results in clay particles being reduced form a size of about 4-5 microns to less than about 1 micron. An effective amount of a high viscosity component is blended into the mill to form the optical fiber composition. Typically the high viscosity component comprises the oligomeric component of the composition. Lastly, the method may include filtering of the composition. Preferably, the composition is filtered to remove particles of about 1 micron or larger. Optionally the method may include repeating the milling step more than once, preferably, at least three times. It is also preferred that all milling steps are completed prior to blending the high viscosity component into the mill.

The method may optionally include the additional step of organically modifying the clay by dispersing an organic substance into the clay. Preferably, the organic substance includes an organic cation, and is dispersed into the clay prior to dispersion of the clay into the low viscosity mixture. Preferably the amount of organic substance dispersed into the clay is on the order of the stoichiometric amount necessary to replace the inorganic cations (e.g. Na⁺, Ca²⁺) in the clay. For example, the ratio of equivalents of the positive charges in the organic substance to exchangeable positive charges in the clay is preferably from about 0.75 to about 6.0, more preferably from about 0.8 to about 5.0, even more preferably from about 1.0 to about 3.0, and most preferably from about 1.2 to about 2.0.

Suitable organic substances for modification of the clay are described hereinabove. For example, suitable organic substances include long chain alkyl surfactants such as at least about 10 carbon atom chains, preferably at least about 12 carbon atoms, more preferably at least about 15 carbon atoms, and most preferably at least about 20 carbon atoms. Suitable surfactants also include aromatic surfactants, such as surfactants including as least one benzyl group or at least one pyridine group. Preferred surfactants include organic surfactants, such as dodecyl-trimethylammonium bromide (“DDTM”) 1-dodecyl-pyridinium chloride hydrate (“DDP”), a quaternary ammonium compound derived from fatty amineethylene oxide condensates such as Ethoquad C/12® (“ETQD”), and N-dodecyl-4-ethenyl-N,N-dimethylbenezene-methanaminuim chloride (“DDMV”).

One technique to disperse the organic substance into the clay is to disperse the clay in a water ion exchange process. First the clay is dispersed in water to exfoliate the clay in water. Preferably the clay is dispersed in the water for a period of at least about 8 hours and any precipitate formed is discarded. Next the organic substance (e.g. surfactant) is added to the aqueous clay solution, along with any acid necessary to render the organic substance cationic. Preferably the surfactant cations associate with the clay platelets, changing the clay into a hydrophobic organoclay and causing it to precipitate. The exchanged inorganic cations and any remaining surfactant remain in solution. The organoclay is collected by filtration and washed preferably to substantially remove the water and any residual surfactant. The filter cake may then be dried and the resultant clay is an organoclay.

A second process which may be used to exfoliate the clay is as follows. First the clay is soaked in water. The time period necessary to soak the clay in water can depend on the temperature of the water and the amount of agitation used to disperse the clay in the water. With respect to room temperature, the clay may be soaked in an agitated water medium for at least about for (4) hours. With respect to water at 60-80° C., the water soak may comprise about 4 hours or less. Regarding agitation the more shear force created by the agitation, the faster dispersion of the clay in the water will occur.

Next, preferably the clay water solution can form a precipitate by allowing the aqueous clay solution to sit overnight (approximately at least twelve (12) hours). Typically heavy metal impurities form a precipitate in the bottom of the solution. Decantation can be used to separate the aqueous clay solution from the precipitate. If time is an issue, centrifugation may be used to accomplish the above precipitation of the heavy metals.

At this point, low angle (≈100) X-ray diffraction may be used to determine if the clay is exfoliated. If the results of the diffraction does not contain substantially any basal spacing peaks, the regular structure of the clay is disrupted and the clay is exfoliated. This may also be known as separation of the individual platelets of the clay by a distance of at least about 20 Ångstroms.

Preferably, after the clay is exfoliated an organic substance such as a cationic surfactant may be added to the clay to swell the clay and transform the clay into an organoclay. One technique to swell the clay is to soak the exfoliated clay in water at about 80° C. for about four (4) to about sixteen (16) hours with agitation. During the water soak one (1) or more ion exchanges may occur by adding the organic substance to the 80° C. aqueous clay.

One function of the ion exchange is to exchange cations such as Na⁺ or Ca²⁺ with organic cations at the platelet surfaces. A preferred minimum ion exchange in at least about 92 mole percent of the cations, more preferably greater than 92 mole percent. The Na⁺ or Ca²⁺ cations typically will remain in the soltion. Decantation can be used to separate the dissolved cations from the organoclay.

Preferably after the ion exchange, the organoclay is dried. It is preferred to remove as much water as practically possible form the organoclay. A vaccum oven with an atmosphere including a drying agent, e.g., P₂O₅, is one apparatus that may be used to dry the organoclay. Preferably the organoclay is stored in a dry environment, such as a container which includes a drying agent such as anhydrous calcium sulfate (available commercially as Drierite®).

As embodied herein another aspect of the invention includes a method of making a coated optical fiber. The method includes the step of applying the aforementioned coating composition to an optical fiber and curing the coating composition. Optionally the method may also include the step of applying an inner primary coating to the fiber and curing the inner primary coating. Preferably the inner primary coating is applied to the fiber prior to the application to the inventive coating composition. The inner primary coating may be cured prior to or simultaneously with the curing of the inventive coating composition. The method may also include the step of drawing the fiber at a rate of at least about 20 m/s.

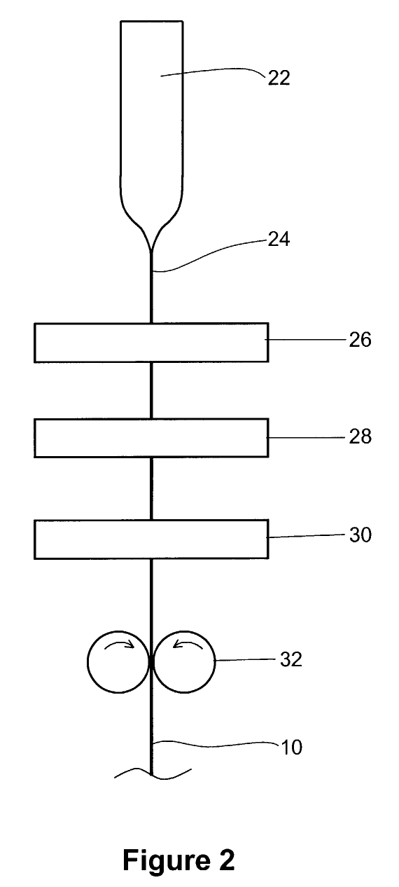

Preferably, the optical fiber of the present invention is drawn from a cylindrical preform which has been locally and symmetrically heated to a temperature sufficient to soften the glass, e.g., about 1800° C. or more for a silica glass. As the preform is heated, such as by feeding the preform into and through a furnace, a glass fiber is drawn from the softened material. The method of making an coated optical fiber is further explained with respect to FIG. 2 generally designated by reference numeral 20.

FIG. 2 is a schematic representation of one of the preferred processes for drawing and coating an optical fiber. The sintered preform 22 is softened and drawn into an uncoated fiber 24. Uncoated fiber 24 is then drawn through two coating dies 26 and 28 where an uncured inner primary coating formulation and an outer primary coating formulation of the present invention, respectively, are applied to fiber 24. The wet coated fiber is then cured by a bank of UV lamps 30. The fiber 10 is drawn from preform 22 and through the coating dies by a pair of tractors 32. Optionally, coating 16 may be cured prior to the application of coating 18. In this embodiment, fiber 24 coated with the uncured inner primary coating formulation is passed through a bank of UV lamps before being passed through coating die 28 for the application of the uncured outer primary coating composition. After the outer primary coating composition is applied, fiber 10 is passed through a second bank of UV lamps.

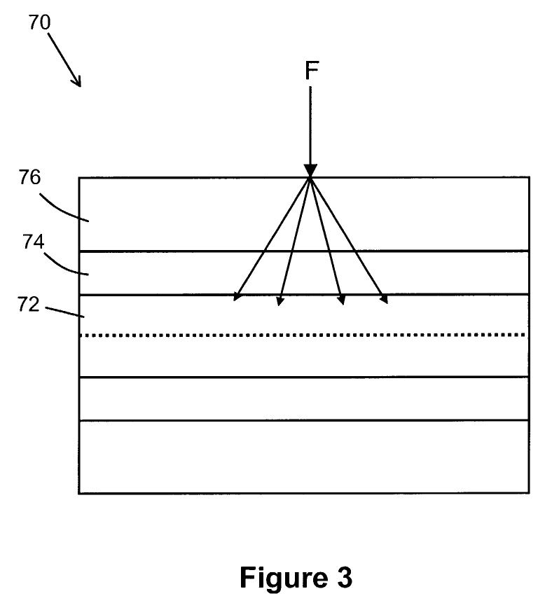

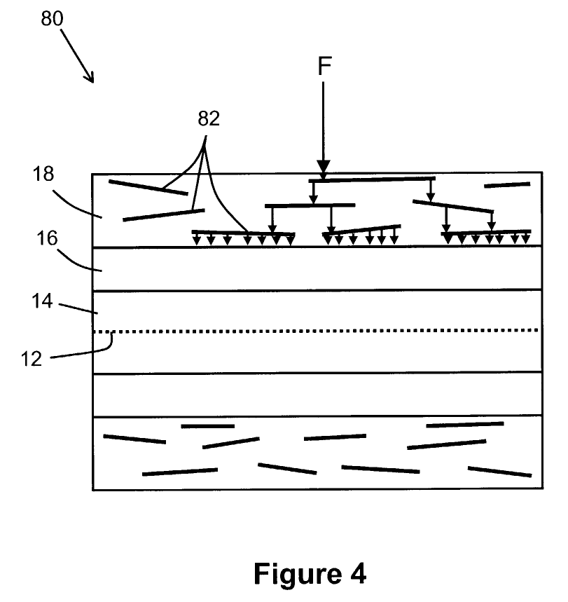

A further aspect of the invention includes a method of dispersing force applied perpendicular to coated optical fiber 10. Preferably the force is perpendicular to the longitudinal axis of the fiber. The method includes the step of coating an exterior surface of an optical fiber with an inner primary coating and applying the aforementioned inventive coating to the fiber. As previously mentioned the inner primary coating and the inventive coating may be cured individually or simultaneously. The method further includes applying the force to the fiber. This aspect of the invention is further described in FIGS. 3 and 4.

Depicted in FIG. 3, generally designated 70 is the application of a schematic diagram of the application of the external force F, perpendicular to the longitudinal axis of a fiber 72 coated with a conventional dual coating system having an inner primary coating 74 and an outer primary coating 76 devoid of an exfoliated clay. As shown in FIG. 3, force F is substantially transmitted radially directly to fiber 72.

Depicted in FIG. 4, generally designated 80 is the application of a schematic diagram of the application of the external force F, perpendicular to the longitudinal axis of the fiber 10 having coatings 16 and 18. Coating 18 includes a plurality of exfoliated layers 82 dispersed in coating 18. As shown in FIG. 4, layers 82 disperse force F such that application of force F to fiber 10 is dispersed along the length of the fiber and therefore, the impact of force F to the core of the fiber is reduced. This reduction in impact may be observed as a reduction in optical loss caused by the application of force F to the fiber.

### EXAMPLES

The invention will be further clarified by the following examples.

### Example 1

Mt-DDTM organoclay was prepared according to the following. Distilled water (3.5 L) was warmed to 60° C., and 50.0 g SWy-2 clay (Sodium Montmorillonite with a CEC of 76.4 meq/100 g from Source Clay Minerals Repository of University of Missouri at Columbia, Mo.) was added to the water over a period of 2-5 minutes, while the water was agitated. Agitation continued for at least an hour after the addition of the clay, forming a clay suspension. The clay suspension was allowed to settle for at least four hours, forming a precipitate. The bottommost layer of precipitate (about 10.0 g) was discarded, and the remaining clay-water mixture was re-heated to 60° C. with agitation. A solution of dodecyltrimethylammonium bromide surfactant (14.1 g, Aldrich) in de-ionized water (200 mL) was added to the clay-water dispersion over a period of 1-5 minutes with rapid agitation (about 500-1000 rpm). Agitation continued for at least three hours following completion of surfactant addition. Vacuum filtration was used to collect the organoclay product. The filter cake was re-dispersed in warm de-ionized water (3.5 L) using rapid agitation, and the organoclay was again collected by vacuum filtration. The same procedure was repeated until the filter cake was bromide free as determined by a silver nitrate test. The product was dried in the air for two days, followed by vacuum drying at 60° C. for at least 12 hours in the presence of P₂O₅ powder. The dried organoclay sample was ground to small particles (<100 μm) and stored in a desiccator.

A polymer-clay nanocomposite coating composition containing Mt-DDTM was prepared. Preliminary experiments were first performed to identify monomers and oligomers which had desired compatibility with the organoclay and would yield a desired modulus range for an outer primary coating. The organoclay Mt-DDTM (2.10 g) and an antioxidant Irganox 1035 (0.17 g, Ciba Specialty Chemicals) were dispersed into tetra(ethyleneglycol) diacrylate monomer (16.4 g, Monomer-Polymer & Dajac Lab, Inc.) by agitation, then homogenized with a Waring blender for several minutes. The CN981 oligomer (16.4 g, Sartomer), pre-warmed to 60° C. to reduce its viscosity, and Irgacure 1850 (1.0 g, Ciba Specialty Chemicals) were then added into the above mixture. The new mixture was then homogenized with a mixer for several minutes. The coating formulation was degassed in a vacuum oven at 60° C. until free of air bubbles.

Glass plates were cleaned with soap and water, rinsed with acetone, and dried. Wet films were cast on the cleaned glass plates using a draw-down box having a gap thickness of 0.005″ (˜127 μm). The films were cured using Fusion UV System with a 600 Watt/in. D-bulb under the following conditions: 50% power, 10 ft/min, and nitrogen purge. The cured films were immediately moved to a 50% relative humidity room where they were aged for at least 16 hours. The thickness of these films were in the range of about 3.0 to about 3.5 mils. The cured films were cut into dimensions of about 1.3 cm by about 15 cm and tested using a MTS Sintech tensile tester following the standard procedure to determine Young's modulus, tensile strength, and percent elongation at break.

### Example 2

The organoclay Mt-ETQD was made in the same manner as in Example 1, using 20.0 g of Ethoquad®C/12 (Akzo Nobel) in place of the dodecyltrimethylammonium bromide. The dried clay was incorporated into a coating composition in the same manner as in Example 1. Films were cast and tested in the same manner as in Example 1.

### Comparative Example 1

A radiation curable resin was made by mixing tetra(ethyleneglycol) diacrylate monomer (17.5 g, Monomer-Polymer & Dajac Lab, Inc.), CN981 oligomer (17.5 g, Sartomer), Irgacure 1850 (1.0 g, Ciba Specialty Chemicals) and Irganox 1035 (0.17 g, Ciba Specialty Chemicals). Films were cast and tested in the same manner as in Example 1.

Table 1 summarizes the results obtained in Examples 1, 2, and Comparative Example 1. In Example 1 the basal spacing of the organoclay was about 34 Angstroms, whereas in Example 2 no peaks were detectable by X-ray diffraction, suggesting a disrupted or an exfoliated clay in the organic matrix. Both Examples 1 and 2 show much higher Young's modulus and satisfactory tensile strength and elongation at break, compared to Comparative Example 1.

TABLE 1

| | Basal | Young's | Tensile | |
|---|---|---|---|---|
| | spacing, (**) | modulus,* | strength,* | Elongation* at |
| Example | Ångstrom | MPa | MPa | break, % |
| Example 1 | 34 | 663 | 19 | 23 |
| Example 2 | Non detectable | 623 | 21 | 33 |
| Comparative | — | 470 | 18 | 22 |
| Example 1 | | | | |

*Tested in accordance with ASTM 882-97 throughout examples
(**)X-ray diffraction patterns were obtained by using Scintag Diffraction Unit with copper radiation and operated at 40 kV and 45 mA..

### Example 3

The cationic reactive surfactant N-dodecyl-4-ethenyl-N,N-dimethylbenzenemethanaminuim chloride (DDMV) was synthesized according to the following procedure: 4-vinylbenzyl chloride (58.5 g, Aldrich) and 2,6-di-tert-butyl-4-methylphenol (0.2 g) were dissolved in diethyl ether (350 mL) at room temperature in a 2- neck round bottom flask equipped with a condenser and addition funnel. The solution was stirred under nitrogen, and N,N-Dimethyldodecylamine (97.9 g, Aldrich) was added dropwise through the addition funnel. The mixture turned milky slowly with time. The reaction flask was covered with aluminum foil after the addition was complete to protect the reaction mixture from light. The mixture was allowed to stir for at least three days, after which the mixture was heated to about 38° C. and anhydrous ethanol was added slowly until the solution became clear. Diethyl ether was gradually added until the solution became cloudy. The product was allowed to crystallize at room temperature and then in a refrigerator overnight. The product crystals were collected by gravity filtration. The product was recrystallized using the procedure described above. The final product was dried in a vacuum oven at room temperature overnight.

Mt-DDMV organoclay was made in the same manner as in Example 1, using 18.2 g of DDMV in place of the dodecyltrimethylammonium bromide.

A polymer-clay nanocomposite coating formulation containing Mt-DDMV organoclay was prepared. The organoclay Mt-DDMV (2.40 g) and Irganox 1035 (0.30 g, Ciba Specialty Chemicals) were dispersed into a mixture of Photomer 4025 (23.0 g, Cognis) and Photomer 4028 (27.1 g, Cognis). The above formed mixture was homogenized using a PowerGen 700 homogenizer for 4 min at a control speed setting of “4”. BR301 oligomer (5.76 g, Bomar) pre-warmed at 60° C., and Irgacure 1850 (1.73 g, Ciba Specialty Chemicals) were then added into the above mixture. This latter mixture was then homogenized for 4 min. The coating composition so formed was degassed in a vacuum oven at 60° C. until free of air bubbles. Films were cast and tested in the same manner as in Example 1, except that a Dynamic Mechanical Analyzer was used to characterize the elastic modulus and the glass transition temperature (Tg) of the films.

### Example 4

A polymer-clay nanocomposite coating composition was prepared in the same manner as in Example 3, except that only 1.20 g of Mt-DDMV organoclay was used. Films were cast and tested in the same manner as in Example 3.

### Example 5

A polymer-clay nanocomposite coating composition was prepared in the same manner as in Example 3, except that only 0.60 g of Mt-DDMV organoclay was used. Films were cast and tested in the same manner as in Example 3.

### Comparative Example 2

A radiation curable resin was made by mixing Photomer 4025 (40.0 g, Cognis), Photomer 4028 (47.0 g, Cognis), BR301 oligomer (10 g, Bomar), Irgacure 1850 (3.0 g, Ciba Specialty Chemicals), and Irganox 1035 (0.5 g, Ciba Specialty Chemicals). Films were cast and tested in the same manner as in Example 3.

Tables 2 and 3 summarize the results obtained in Examples 3, 4, 5 and Comparative Example 2. The Young's modulus increases with only 1 wt % of organoclay as compared to Comparative Example 2. The more clay that is added, the more the Young's modulus increases. A moderate increase in tensile strength and decrease in elongation at break was also observed. From Table 3, a slow but steady increase in glass transition temperature is observed with increasing organoclay loadings, compared to Comparative Example 2.

In addition to the elastic modulus of the coatings in Examples 3, 4, 5, as measured by DMA, being higher than that of Comparative Example 2, the glass transition temperature, a characteristic important for optical fiber outer primary coatings, of the Example coatings was also higher than that of the Comparative example. Furthermore, at 50° C., the elastic modulus of Example 3 was 87% higher than that of Comparative Example 2.

TABLE 2

| | | | Tensile | |
|---|---|---|---|---|
| | Basal spacing, | Young's | Strength, | Elongation |
| | Ångstrom | modulus, MPa | MPa | % |
| Example 3 | 32 | 783 | 21 | 21 |
| Example 4 | 32 | 827 | 21 | 19 |
| Example 5 | Non-detectable | 917 | 22 | 19 |
| Comparative | — | 717 | 19 | 24 |
| Example 2 | | | | |

TABLE 3

| | Elastic Modulus, MPa | | Glass Transition |
|---|---|---|---|
| Example | 50° C. | 100° C. | Temperature, ° C. |
| Example 3 | 745 | 585 | 41.7 |
| Example 4 | 644 | 523 | 41.0 |
| Example 5 | 600 | 507 | 40.7 |
| Comparative Example 2 | 399 | 390 | 37.3 |

### Example 6

Polymer-clay nanocomposite coating composition containing Nanomer 1.28E, an organoclay available from Nanocor, was prepared in the following way: Nanomer 1.28E (2.40 g) and Irganox 1035 (0.30 g, Ciba Specialty Chemicals) were dispersed into a mixture of Photomer 4025 (34.2 g, Cognis) and Photomer 4028 (6.0 g, Cognis). The above formed mixture was homogenized using PowerGen 700 for 4 minutes at a control speed setting of “4”. PH3016 (18.0 g, Cognis), pre-warned at 60° C., and Irgacure 1850 (1.8 g, Ciba Specialty Chemicals) were then added into the above mixture. The mixture was then homogenized for 4 minutes. The formulation was degassed in a vacuum oven at 60° C. until free of air bubbles. Films were cast and tested in the same manner as in Example 1.

### Example 7

A polymer-clay nanocomposite coating composition containing Mt-ETQD was prepared in the same manner as in Example 6, using 2.4 g of the Mt-ETQD organoclay of Example 2 was in place of the Nanomer 1.28E. Films were cast and tested in the same manner as in Example 1.

### Example 8

A polymer-clay nanocomposite coating composition containing Mt-DDTM was prepared in the same manner as in Example 6, using 2.4 g of the Mt-DDTM organoclay of Example 1 was in place of the Nanomer I.28E. Films were cast and tested in the same manner as in Example 1.

### Example 9

A polymer-clay nanocomposite coating composition containing Mt-DDMV was prepared in the same manner as in Example 6, using 2.4 g of the Mt-DDMV organoclay of Example 3 was in place of the Nanomer 1.28E. Films were cast and tested in the same manner as in Example 1.

### Example 10

The cationic reactive surfactant [3-(acryloyl)propyl]dodecyldimethylammonium chloride (DDMA)) was synthesized according to the following. 3-(Dimethylamino)propyl acrylate (4.0 g, Aldrich) and bromododecane (6.21 g, Aldrich) were mixed together and heated to 60° C. overnight (at least 8 hours). The mixture turned into a solid and was dissolved into methanol. The methanol solution was precipitated into diethyl ether. The top layer was discarded and the bottom layer was dried under high vacuum.

Mt-DDMA organoclay was made in the same manner as in Example 1, except that a 1:1 volume mixture of water and ethyl alcohol was used as the ion exchange medium, and 11.2 g of SWy-2 clay and 4.49 g of the above DDMA reactive surfactant were used for the ion exchange.

A polymer-clay nanocomposite coating composition containing Mt-DDMA was prepared in the same manner as in Example 6, except that 2.4 g of Mt-DDMA organoclay was used. Films were cast and tested in the same manner as in Example 1.

### Comparative Example 3

A radiation curable resin was made by mixing Photomer 4025 (57.1 g, Cognis), Photomer 4028 (10.0 g, Cognis), PH3016 (30.9 g, Cognis), Irgacure 1850 (3.0 g, Ciba Specialty Chemicals), and Irganox 1035 (0.59 g, Ciba Specialty Chemicals). Films were cast and tested in the same manner as in Example 1.

The results of the testing of Examples 6-10 and Comparative Example 3 are shown in Table 4. The examples all had a higher Young's modulus and glass transition temperature than Comparative Example 3.

TABLE 4

| | Basal | Young's | Tensil | | |
|---|---|---|---|---|---|
| | spacing, | Modulus, | Strength, | Elongation, | Tg, |
| Example | Ångstrom | MPa | MPa | % | ° C. |
| Example 6 | 38 | 872 | 17.9 | 11.8 | 43.3 |
| Example 7 | 34 | 893 | 21.2 | 16.4 | 43.2 |
| Example 8 | Non- | 1157 | 23.2 | 9.9 | 39.8 |
| | detectable | | | | |
| Example 9 | 32 | 1172 | 24.3 | 12.7 | 45.4 |
| Example 10 | 33 | 1068 | 22.1 | 14.9 | 42.4 |
| Comparative | — | 758 | 23.5 | 25.7 | 34.3 |
| Example 3 | | | | | |

### Example 11

The nanocomposite coating composition described in Example 7 was scaled up and coated onto SMF-28 fiber while the fiber was being drawn at a rate of about 20 m/s. The coating concentricity, the degree of cure, optical attenuation at 1310 and 1550 nm wavelengths at room temperature as well as 65° C. were tested. The fiber was also subjected to the 4 mm Rack Test, as described hereinbelow.

### Example 12

The nanocomposite coating formulation described in Example 8 was scaled up and coated onto SMF-28 fiber under the same conditions as in Example 11. This fiber was subjected to the 4 mm Rack Test, as described hereinbelow.

### Comparative Example 4

The radiation curable coating formulation described in Comparative Example 3 was scaled up and coated onto SMF-28 fiber under the same conditions as in Example 11. The coated fiber was tested in the same manner as in example 11

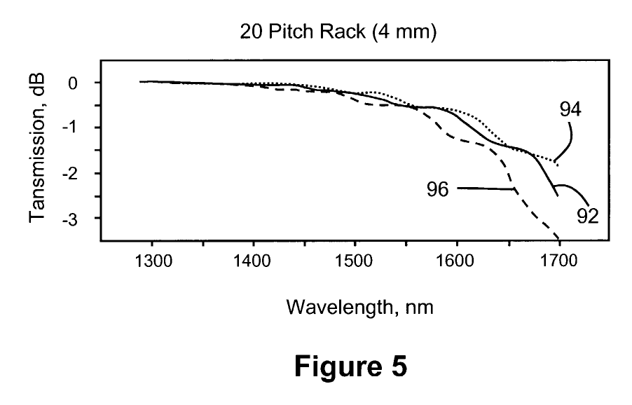

Table 5 shows the test results of the two fibers (Example 11 and Comparative Example 4). The fiber coated with nanocomposite has lower optical losses than the one coated with the coating with no organoclay additives. FIG. 5 gives the 20 pitch, 4 mm Rack Test results as a plot of transmission loss vs. wavelength. The two test fibers in Examples 11 (92) and 12 (94) show less microbend sensitivity than the Comparative Example 4 (96).

TABLE 5

| | Example 11 | Comparative Example 4 |
|---|---|---|
| Degree of Cure | >99% | 100% |
| Maximum change in attenuation | | |
| −60° C. to 85° C. (in dB/km) | | |
| 1310 nm | 0.02 | 0.19 |
| 1550 nm | 0.03 | 0.41 |
| Maximum change in attenuation | | |
| 0° C. to −60° C. (in dB/km) | | |
| 1310 nm | 0.02 | 0.18 |
| 1550 nm | 0.03 | 0.41 |
| Maximum change in attenuation | | |
| 30 day soak in 23° C. H₂O | | |
| 1310 nm | 0.005 | 0.008 |
| 1550 nm | 0.016 | 0.000 |

### Example 13

Mt-2-DDP organoclay was prepared by using SWy-2 clay and 1-dodecylpyridinium chloride hydrate (DDP, Aldrich). SWy-2 (50 g) was dispersed with agitation into deionized water (3.5 L) pre-heated to 80° C. Agitation continued for at least an hour after which the mixture was removed from heat and set aside to settle overnight (at least 8 hours). The top clay suspension was collected by decantation and the residue remaining at the bottom was discarded. The top clay suspension was then reheated to 80° C. with constant agitation. 1-Dodecylpyridinium chloride hydrate (DDP, 17.0 g) was dissolved into 200 mL of deionized water and was slowly added to the clay-water suspension with increased agitation. This reaction was allowed to continue for at least 4 hours. The mixture was then filtered using vacuum filtration. As the water was removed, a filter cake of clay was formed. This filter cake was re-dispersed into deionized water (3.5 L) preheated to 80° C. and DDP (17.0 g) dissolved in 100 g deionized water was slowly added to the new clay dispersion for a second ion exchange. This reaction was allowed to continue for another 4 hours. The mixture was then vacuum filtered. The new product (Mt-2-DDP) was then rinsed using deionized water and re-filtered for an additional three times until the filter cake was halide-free, by silver nitrate titration as previously described in Example 1. The clay product was allowed to air dry for several days, followed by vacuum drying at 60° C. in the presence of phosphorus pentoxide (P₂O₅) for 1-2 days. The Mt-2-DDP organoclay was then ground to small particles (<100 μm) and stored in a desiccator.

A clay-polymer nanocomposite coating composition containing Mt-2-DDP was prepared according to the procedure described below. PH4025 (366.43 g, Cognis), PH4028 (64.29 g, Cognis), Irgacure 1850 (3.0 g, Ciba Specialty Chemicals), Irganox 1035 (19.29 g, Ciba Specialty Chemicals), and Mt-2-DDP (25.71 g) were placed into a Waring Blender jar and were first manually mixed together, and then mixed using the blender on the low setting for 5 minutes, then the high setting for 5 minutes, and then on the low setting again for another 5 minutes. Six more batches were made in the same manner. The combined composition was then milled using a Eiger mill (0.8 mm zirconium oxide media) to further disperse and reduce the particle size of the organoclay. The composition entered the mill through a large cup and was fed into the mill using a mechanical stirring system. Compressed air was used to power the stirring system. The pressure formed pushed the composition through the mill's grinding chamber and then out an exit tube to be collected and reinserted into the mill. The milling process used several passes through the machine. The total milling time lasted for 2½ hours at 3000 RPM. During the milling process cooling water was used frequently to reduce the temperature of the mill. About 86% of the composition was recovered after the milling process.

The PH3016 material (1158 g, Cognis), pre-warmed to 60° C., was blended into the milled mixture (3353 g) in seven portions each containing about 479 g of the milled mixture and 165.43 g of PH3016. The final composition was heated to 60° C. in an oven and placed into a filtration system and forced through a 1 μm filter cartridge (final filtration). The total percentage recovered was 67%. The filtered nanocomposite composition was placed in an oven set between 40 and 45° C. for two days to age the composition. It was then degassed at 60° C. under low vacuum. Films were cast and tested in the same manner as in Example 1. Thermal gravitational analysis (TGA) shows that up to three quarters of the organoclay remained in the coating after milling and filtration procedures. Using this nanocomposite composition as outer primary coating and 31 the coating of table 6 as inner primary coating as cited below, a SMF-28™ fiber was coated and cured by applying a 3P/3S UV configuration at 20 m/s. The coated fiber was screened at 100 KPSI. Microbend sensitivity was tested using expandable drum (“EDM”) and lateral load wire mesh (“LLWM”).

TABLE 6

| | | |
|---|---|---|
| Primary coating: | 52% BR3731 | 1.5% Irgacure 184 |
| | 45% PH4003 | 1.5% Irgacure 819 |
| | | 1 pph Irganox 1035 |
| | | 2 pph |
| | | bis(trimethoxysilylethyl)benzene |
| | | 0.3 pph mercaptopropyl- |
| | | trimethoxysilane |

The EDM test is performed as follows. The test measures the slope of attenuation loss due to strain at different wavelengths of light. To perform the test, a length of fiber 750 m long is tension wound at 70 grams of tension in a single layer, with no crossovers on an expandable drum. The expandable drum surface is made from High Impact Polystyrene to prevent damage to the fiber and should be free of scratches and contaminates that could cause premature microbending to occur. The expandable drum is a drum with a unexpanded diameter of 30 cm (55 cm in length) that can be expanded uniformly to apply strain to the fiber wound on the drum. Each time the drum diameter was increased the diameter was increased about 2 mm or less. The diameter of the drum was expanded four times during the testing procedure. The drum includes a mechanism that will allow a user to controllably apply a strain to the fiber on the drum by increasing the diameter of the drum having fiber wound onto the drum. The increase in diameter of the drum is controlled by the movement expansion element. To expand the diameter of the drum, the expansion element is turned 90° in a clockwise direction. Each time the expansion element is turned 90° the drum diameter is expanded. As the drum expands, an elongation force is applied to the fiber. An example of the elongation force applied to a sample of SMF-28™ fiber, in terms of percent strain, is listed in Table 7.

TABLE 7

| Degree of Turn of | % Strain |
|---|---|
| Expansion Element | (Sample size was 15) |
| 90° | ≦0.053 |
| 180° | 0.138 |
| 270° | 0.212 |
| 360° | ≧0.296 |

The data point for 90° is the minimum percent strain for any one sample. Likewise, the data point for 360° is the maximum data point. The data points for 180° and 270° are the respective averages for each point.

The attenuation loss of the fiber is measured at wavelengths of 1310, 1550 and 1625 nm as initially wound on the drum and at the four strain increments of the expandable drum using a Photon Kinetics Model 2500 spectral attenuation bench-optical fiber analysis system (manufactured by Photon Kinetics of Beaverton, Oreg.). The user's manual for the model is incorporated herein by reference. The use of Model 2500 to perform the attenuation measurement is explained therein. The five measurements taken at each light wavelength of 1310, 1550 and 1625 nm are then plotted to determine the slope of attenuation loss due to strain.

The LLWM test is performed as described below. This test measures the spectral power of light launched through a fiber as a lateral load is applied to the fiber. Lateral load is a force normal to a cross section of the fiber. Each sample was tested 5 times, and an average result reported.

A length of fiber is extended from a light source (a.k.a. launch stage) to a detector stage. A preferred detector stage is a Photon Kinetics (hereinafter “PK”) spectral attenuation measurement bench. A suitable device is Model 2500, optical fiber analysis system, from Photon Kinetics of Beaverton, Oreg. The user's manual for the model is herein incorporated by reference. The use of Model 2500 to perform the attenuation measurement is explained therein. The length of fiber must be sufficient to extend from the light source to the measurement bench. The length of fiber also should include a loose predetermined configuration of fiber disposed on an INSTRON® mechanical stress/strain measurement device as described below.

An INSTRON® mechanical measuring device is used to apply a lateral load on the fiber. The INSTRON® mechanical measuring device is a device capable of controllably applying a load on a material. The force of the load can be controlled and measured along with the rate of loading as a function of time. Further, the deformation imposed on the test sample of material (the piece of fiber) during the course of the loading event can be measured as well. For these tests an INSTRON® Model No. 4502 was used. This device was manufactured by Instron Corporation of Canton, Mass. Similar devices are available from other manufacturers.

The INSTRON® Model 4502 has a lower steel plate and an upper steel plate. The plates are oriented such that the force imposed by the upper plate on the lower plate is normal to the lower plate. The sample of fiber to be tested is placed on a rubber pad attached to the lower plate. The rubber pad has a Shore A Hardness of 70+/−5. It is essential to ensure that the rubber pad is flat and not marked by grooves of any sort. If necessary, the pad should be replaced or cleaned with isopropyl alcohol.

The fiber is looped approximately 340 degrees around a mandrel having a diameter of 98.5 mm. The fiber may be held in place on a rubber pad by no more than three pieces of thin tape with a maximum width of 3 mm each. A portion of the pad is cut away to prevent fiber crossover at the point where the fiber ends exit the INSTRON® mechanical testing device.

The mandrel is removed and a number 70 wire mesh is placed on top of the fiber loop on the rubber pad, sandwiching the fiber between the rubber pad and the wire mesh. An initial attenuation of the fiber is recorded at 1310 nm, 1550 nm and 1625 nm. A compressive lateral load is applied to the fiber in increments of 10 N. The total lateral load applied is increased up to 70 N. The induced attenuation is recorded for each incremental increase in lateral load. The average change in attenuation is calculated for each incremental load between 30 N and 70 N. The test may also be used to record the change in attenuation in terms of change in decibels (ΔdB) at each of the three aforementioned wavelengths.

The LLWM test results reported below are the 70-30N induced attenuation. This is calculated using the following equation for each wavelength, then normalized to meters by dividing by the length of fiber under test (e.g., approximately 0.3m).

dB Loss =(−10×log10(70N Power/30N Power))/0.3m

### Comparative Example 5

A radiation curable resin was made in the same manner as in Example 12, except that 2008 g of Photomer 4025 (Cognis), 1000 g of Photomer 4028 (Cognis), 800 g of Ph3016 oligomer (Cognis), 120 g of Irgacure 1850 (Ciba Specialty Chemicals), and 20 g of Irganox 1035 (Ciba Specialty Chemicals) were used and no milling was performed. This coating was designed to have similar tensile properties to the nanocomposite described in Example 12, so that the coated fiber could serve as a control for comparisons. Films were cast and tested in the same manner as in Example 1. A SMF-28™ fiber was coated and tested in the same manner as in Example 12, except that this formulation instead of the nanocomposite was used as an outer primary coating.

Table 8 gives mechanical properties of cured films. As can be seen, the two coatings have very similar tensile properties. Table 9 summarizes microbend sensitivity results for the two fibers in Example 13 and Comparative Example 5, as well as a commercial control fiber coated with CPC6 (E) an urethane acrylate outer primary coating from DSM-Desotech of Elgin IL as an outer primary coating. It is clear that the nanocomposite coated fiber in Example 13 exhibited much less microbend sensitivity compared to either the control fiber with CPC 6(E) or the control fiber in Comparative Example 5.

TABLE 8
Film properties.

| | | | Young's | Secant |
|---|---|---|---|---|
| | T. Strength | Elongation | Modulus | Modulus |
| Example | MPa | at Break, % | MPa | MPa |
| Example 13 | 19.63 ± 1.12 | 15 6 ± 1.4 | 872 ± 46 | 441 ± 30 |
| Comparative | 21.98 ± 1.86 | 19.9 ± 4.1 | 925 ± 90 | 538 ± 51 |
| Example 5 | | | | |

TABLE 9
Lateral Load (LL) and Expandable Drum (ED) microbend test results.

| | | | | | | | |
|---|---|---|---|---|---|---|---|
| | MFD | L. Load | L. Load | L. Load | E. Drum | E. Drum | E. Drum |
| Example | μm | 1310 nm | 1550 nm | 1625 nm | 1310 nm | 1550 nm | 1625 nm |

| | | | | | | | |
|---|---|---|---|---|---|---|---|
| Example 13 | 9.02 | 0.029 | 0.096 | 0.135 | 0.099 | 0.281 | 0.416 |
| Control CPC 6(E) | 9.02 | 0.256 | 0.505 | 0.672 | 0.275 | 0.859 | 1.462 |
| Comparative Example 5 | 9.13 | 0.100 | 0.199 | 0.269 | 0.159 | 0.483 | 0.843 |
| Control CPC 6(E) | 9.13 | 0.288 | 0.554 | 0.764 | 0.286 | 0.927 | 1.613 |

### Example 14

Oligomers/Monomers

Photomer 4025 and Photomer 4028 are bisphenol A ethoxylate diacrylates from Henkel with a molecular weight of 689 and 513, respectively. Photomer 3016 is a difunctional epoxy acrylate from Cognis. Irgacure 1850 and Irganox 1035 were purchased from Ciba Specialty Chemicals. All materials were used as received.

SMF-28 fibers were coated using the control formulations and the same glass blank, and tested in the same manner as the nanocomposite.

A nanocomposite (Example 14) coating composition was first prepared by dispersing Mt-2-DDP into a formulation of 1710 g of Photomer 4025, 306 g of Photomer 4028, 901 g of Photomer 3016, 90 g of Irgacure 1850 and 15 g of Irganox 1035. followed by further mixing with a bead mill. After milling, only 80g out of 300 g (only 27%) of the coating was collected due to the high viscosity. A second batch of the nanocomposite coating composition was made by blending the organoclay first into the two less viscous monomers, Ph4025 and Ph4028, followed by milling. A much improved yield (˜60%) of the resin was achieved. The more viscous PH3016 as well as the other components (I-1035 and I-1850) were added in proportions and the mixture was once again blended. More information about Example 14 composition is given in Table 10.

A control coating composition was formulated with 1710 g of Photomer 4025, 306 g of Photomer 4028, 901 g of Photomer 3016, 90 g of Irgacure 1850 and 15 g of Irganox 1035. The control composition was not milled.

The Example 14 formulation was made by pre-mixing all the components with a blender. Film properties of the nanocomposite (Example 14) were very similar to that of the control, as seen from Table 11. The viscosity data of the formulations are shown in Table 12. It is generally true that the nanocomposite is more viscous due to the thickening effect of the particles.

TABLE 10
Organoclay and nanocomposite coating.

| | Formulation | Filter size | | Screening at |
|---|---|---|---|---|
| Organoclay | ID | μm | X-ray | 100 KPSI |
| Mt-2-DDP | Example 14 | 1 | Exfoliated | Good |

TABLE 11
Film properties of nanocomposite coating and its control.

| Fiber | Y. Modulus | T. Strength | % Strn |
|---|---|---|---|
| ID # | MPa | MPa | at Break |
| Control | 861 ± 87 | 19.68 ± 0.88 | 14.0 ± 3.9 |
| Example 14 | 908 ± 108 | 21.22 ± 1.24 | 14.4 ± 3.1 |

TABLE 12
Viscosity of outer primary coatings.

| | | Example 14 | Control Viscosity, |
|---|---|---|---|
| Temp., ° C. | RPM | Viscosity, Poise | Poise |
| 25 | 50 | 58.0 | 34.0 |
| 35 | 150 | 10.5 | 12.6 |
| 45 | 350 | 5.90 | 5.50 |
| 55 | 550 | 4.00 | 2.70 |
| 65 | 750 | 2.10 | — |

Table 13 shows the yield of Example 14 following milling and filtration. Very good coating recovery was achieved.

TABLE 13
Yields of nanocomposite following milling and filtration.

| | Yield after | Yield after | Overall | Filtration |
|---|---|---|---|---|
| Coating | mill % | filtration, % | yield % | time |
| Example 14 | 85 | 69 | 59 | ˜10 min |

TGA Analysis of Coatings

In order to determine the clay concentration after milling and filtration, a cured film of Example 14 was submitted for Thermobgravimetric Analysis (TGA). The results are given in Table 14. Thermogravimetric Analysis (TGA) experiments were performed in the air at a heating rate of 10° C./min from 25 to >815° C. Originally, 3.83 wt % of the organoclay was added. Since the organic surfactant accounts for 24 wt % of the weight of the organoclay, the actual clay concentration in the nanocomposite was only 2.91 wt % before milling and filtration operations for Example 14. In the case of Example 14, the residue was 2.5 and 2.90 wt %. After subtracting the residue in the control formulation, there is still and 2.2 wt % of ash left due to the clay, which suggests nearly 80% recovery of the clay in the coating after milling and filtration.

TABLE 14
TGA results for cured films after 800° C.

| | | | | Clay ash after |
|---|---|---|---|---|
| | Organoclay | Clay Ash | Actual weight | milling & |
| Film | Added, wt % | wt % | Loss, wt % | filtration, wt % |
| Control | — | — | 99.3 | — |
| Example 14 | 3.83 | 2.91 | 97.1 | 2.2 |

Fiber Drawing

SMF-28™ Fibers were drawn and coated using standard methodologies. The coating from Table 6 was used as inner primary coating in all cases. The Example 14 coated fiber was successfully screened at 100 KPSI. The Example 14 coating was filtered using the 1 μm filter. The degree of cure of the Example 14 coated fiber was very similar to that of the control. The degree of cure of the nanocomposite inner primary coating was slightly lower than normal as shown in Table 15. The fibers were subjected to bend testing as described below.

TABLE 15
Degree of Cure of Control and Example 14 fibers.

| Sample | % Cure, Average |
|---|---|
| Example 14 | 91.88 ± 0.14 |
| 20 m/s 3P/3S. Primary | |
| Example 14 | 98.39 ± 0.59 |
| 20 m/s 3P/3S. Secondary | |
| Control | 93.80 ± 0.25 |
| 20 m/s 3P/3S. Primary | |
| Control | 98.57 + 0.18 |
| 20 m/s 3P/3S. Secondary | |

Rack Test

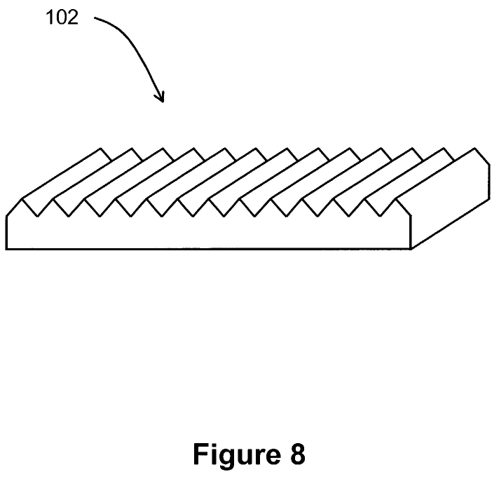

A primary tool for the study of the bend loss of the coating compositions described above is known herein as the rack test. The name of this measurement (“rack test”) comes from the linear rack elements used to apply the bends to the fiber. Their main attribute is the rigid, periodic structure of the teeth on the engaging surface of the rack element. A perspective view of an exemplary rack element 102 is shown in FIG. 8. The rack element suitably has a substantially periodic surface structure; for example, rack element 102 has a generally sawtooth shape. The particular structure of the teeth can be selected to place well-defined periodic bends on an optical fiber. By placing a rack element on either side of a fiber where the teeth of each rack element are 180° out-of-phase, the fiber can be bent in a sinusoidal path along the length of the racks. A single mode (at 1550 nm) optical fiber engaged with rack elements having a period of greater than about 700 mm tend to exhibit macrobending behavior. A single mode (at 1550 nm) optical fiber engaged with rack elements having a period of less than 1 mm tend to exhibit microbending behavior. The racks may be configured to engage the optical fiber with a constant force, or with a constant displacement.

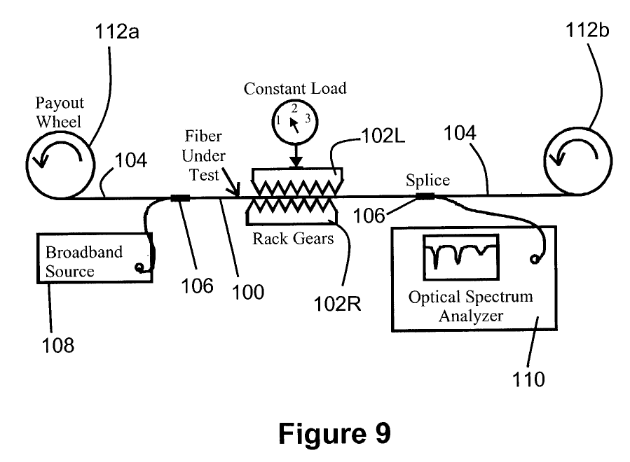

While rack elements are used to bend the fiber, the measurement of optical loss is made possible by launching light through the fiber and subsequent detection of the light. By comparing the loss with and without engagement of the rack elements, the bend-induced loss can be calculated. FIG. 9 shows a schematic of the rack measurement system.

As shown in FIG. 9, the fiber under test 100 is allowed to move between the rack elements 102 for the purpose of averaging any coating or fiber variations. Fiber 100 is measured at many positions along its length, and moved between application of rack elements 102. For the reason that bending is to be strictly controlled during this measurement, it is desirable to keep fiber 100 completely straight outside the rack region. Mechanical fibers 104 are included in the splice protectors 106 at each end of the fiber under test; these fibers provide the tension and motion control for fiber 100 while remaining independent of the measured loss. Preferably, the rack bending is applied with a constant force.

Fiber under test 100 follows a path between rack elements 102, and is illuminated at one end by a source 108 whose light is received at the output end by an optical detector. For example, as shown in FIG. 9, the optical detector may be an optical spectrum analyzer (OSA) 110. Alternatively, the detector may be an optical photodiode combined with a tunable filter; or even a simple detector when the source is tunable. Fiber 100 is spliced to optical fiber (e.g. SMF-28™) leads from both the source 108 and OSA 110 to complete the optical path, and another fiber 104 is included in the splice protectors at each end as a mechanical member for applying tension and controlling the position of fiber 100. Optionally, a magnetic holder (not shown) with a KIMWIPE (disposable cloth) containing alcohol is placed on both sides of racks 102 to clean fiber 100 before it passes between racks 102 for measurement. The pulleys 112 on either side of rack gears 102 provide support for the fiber tension and guidance. In the embodiment shown in FIG. 9, pulley 112a (designated “payout wheel” in FIG. 9) is configured to provide translation to the fiber under test to allow different segments of the fiber to be engaged by the rack elements. For example, pulley 112a may be mounted to a linear translation stage. Alternatively, a rotary actuator may be coupled to pulley 112a to allow the pulley to pay out or take up the mechanical fiber 104. Pulley 112b of FIG. 9 is configured to maintain a constant tension on the fiber under test 100. For example, pulley 112b may be coupled to a linear actuator and a spring. Alternatively, a weight or a mechanical clutch with constant slip tension may be used to provide the constant tension. The skilled artisan will recognize that the apparatus may be configured in many other ways to provide a constant tension on the fiber under test.

The rack elements 102 used in the apparatus of FIG. 9 are 11 inches in length with either about 4 mm period or about 665 μm period between adjacent teeth on each rack element 102. The right rack element 102R is generally fixed in a stationary position, meaning that it is first attached with 4 screws to a stainless steel block which is subsequently bolted directly to an optical table. The left rack element 102L is configured to be movable to engage fiber 100 for the study of fiber loss. This is accomplished by bolting rack element 102L to a larger stainless steel plate that is subsequently bolted to a large, rigid linear translation stage (Newport Model #M-UMR12-40) affixed to the optical table. A position monitor (Starrett Indicator Model #65819) is used to keep track of the distance of left rack element 102L has moved.

While the mechanical linear-motion stage allows left rack element 102L to move and engage fiber 100, this stage's position is controlled by a stepper motor (Aerotech Model #BMS60-UFA) attached to the stage with a high-tensile strength wire. The motor's movement of the stage is opposed by an adjustable weight, attached to the other side of the stage and draped over the edge of the optical table by a pulley (not shown). The deformation of the rack is therefore accomplished by the following events:

The stepper motor turns in the direction of the stage, allowing the stage and left rack element 102L to move toward fiber under test 100;

The left rack element 102L contacts fiber under test 100;

The motor continues to turn toward the stage until its connecting wire becomes tensionless (slack) and the full weight from the opposing wire is upon the fiber under test 100; and

After loss is optically measured on the optical spectrum analyzer 110, the motor turns away from the stage to move the stage and rack element 102L back to their original positions, not in contact with fiber under test 100.

A LABVIEW software program is used to automate and operate the entire rack measurement, especially the stepper motor movement that engages the rack elements 102. Due to the time-dependent creep of typical acrylate coatings, the duration of the load application to the fiber under test should be carefully controlled. For example, the rack elements may be held together (thereby engaging the fiber 100) for 6 seconds, then released to their original positions. This amount of time is convenient for measurement throughput, though most any other time duration may be used, provided it is consistently employed for all fibers being tested and compared. Beyond the application of the load to the fiber, the software program also advances fiber 100 for subsequent measurements. To generate the data discussed herein, a total of seven measurements are collected on fiber 100, and the linear average of the seven measurements is reported.

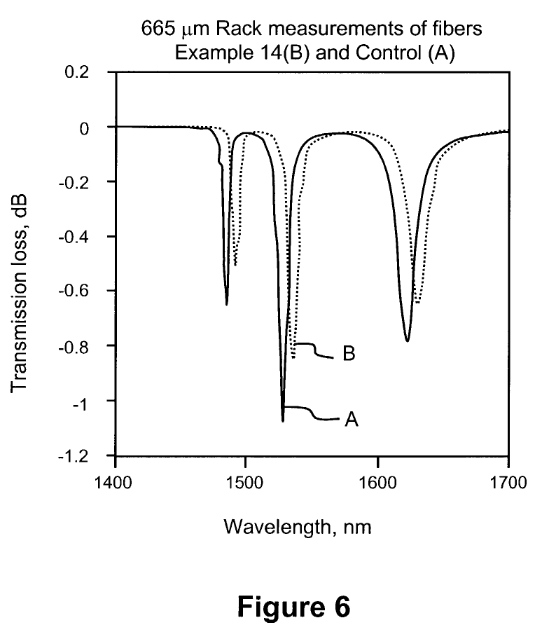

The rack test can employ rack elements having a wide range of tooth periodicities and overall lengths. The selection of the periodicity of the rack elements allows the skilled artisan to simulate microbending or macrobending, as well as compare the index profiles of the fibers under test. The length of the rack element will affect the nature of the loss peaks (e.g. width and depth), and may be selected by the skilled artisan to suit the desired measurement system. As described above, the microbending and macrobending may be classified depending on the physical mechanism underlying the loss of light in the fiber. Through extensive testing and modeling, it has been determined that a rack tooth period of 4 mm produces macrobending loss in most single mode, high data rate optical fibers, while significantly smaller rack periods (e.g. 665 μm) produces microbending. One example of microbending rack test data for an optical fiber of the present invention is shown in FIG. 6. In this test, the rack has a 665 μm period. Microbending behavior is manifested as a series of loss peaks, each corresponding to coupling of the fundamental guided mode of the fiber to a higher-order cladding mode. The wavelength location of these peaks is uniquely determined by the fiber index profile, with the loss occurring where the Δβ between the fundamental and higher-order mode is equal to 2π/Λ, where Λ is the rack tooth periodicity. The locations of the loss peaks in a microbending rack test can be used to compare the index profiles of different fibers. When two optical fibers display the same peak structure at the same wavelength locations, the fibers are believed to have equivalent index profiles. From experimental practice, a wavelength difference in excess of about 10 nm for the loss peaks for two different fibers is sufficient to indicate significant differences in the index profiles. This difference has serious implications when comparing the optical loss of differently-coated optical fibers; since the index profile has a much higher effect on the loss of the light in the fiber than does the coating, the index profiles of different fibers must be as similar as possible in order for a meaningful comparison to be made. As the skilled artisan will appreciate, the rack test has utility beyond the measurement of microbending losses. For example, microbending rack test loss peak locations and Δβ values of two different fibers may be compared to yield valuable information about the similarity of the index profiles of the two fibers.

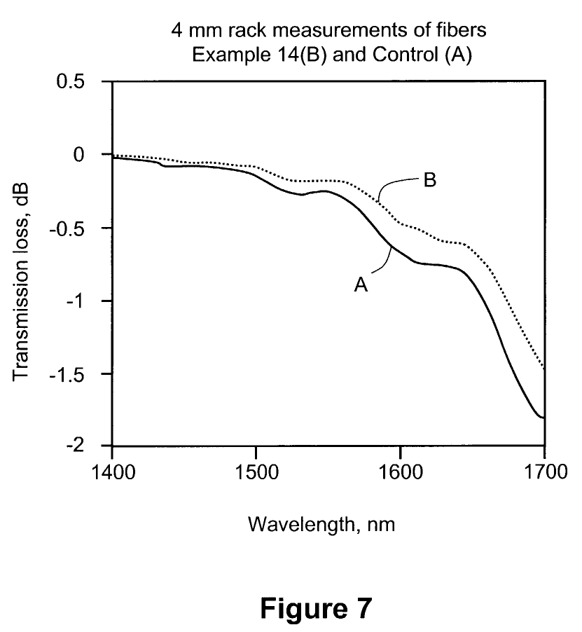

SMF-28™ fibers coated with the composition of Example 14 and its control were measured for microbending sensitivity using the method and apparatus described above. First, the fibers were measured for index profile difference to determine the glass similarity before attempting to compare coating effects on bend loss. Example 14 was closely aligned to its control (only ˜7 nm apart). The Example 14 and control samples were measured for losses when engaged with 4 mm period rack elements and 665 μm period rack elements. FIGS. 6 and 7, respectively, show the results from these measurements, clearly favoring Example 14 fiber for greater protection. The 4 mm rack test showed 30% less macrobend sensitivity compared to the control, while 20% more microbend resistance was observed in 665 μm rack test.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An optical fiber coating composition comprising:
a UV curable formulation which comprises no more than about 55 weight percent of an acrylate oligomer; and
a substantially exfoliated clay, wherein said composition when cured has a Young's Modulus of at least about 100 MPa at room temperature.

2. The composition according to claim 1 wherein said exfoliated clay comprises a fully exfoliated clay.

3. The composition according to claim 1 wherein said exfoliated clay comprises montmorrilonite.

4. The composition according to claim 1 wherein said formulation further comprises an epoxy acrylate.

5. The composition according to claim 1 wherein said formulation further comprises at least one bisphenol acrylate functional component.

6. The composition according to claim 1 wherein said formulation comprises no more than about 10% of an epoxy acrylate component.

7. The composition according to claim 1 wherein said formulation further comprises a hydroxyl functional monomer.

8. The composition according to claim 1 wherein said formulation further comprises at least 40% of a monomeric component.

9. The composition according to claim 8 wherein said monomeric component comprises at least two monomers.

10. The composition according to claim 1 wherein said composition comprises a free radical cure system.

11. The composition according to claim 1 wherein said composition comprises a cationic cure system.

12. The composition according to claim 1 wherein said clay comprises a synthetic clay.

13. The composition according to claim 1 wherein said clay comprises a natural clay.

14. The composition according to claim 1 wherein a concentration of said clay comprises up to about 25 weight percent.

15. The composition according to claim 1 comprises substantially devoid of said acrylate oligomer.

16. The composition according to claim 1 further comprises at least two multifunctional acrylate monomers.

17. The composition according to claim 1 wherein said clay comprises an organoclay having a ratio of positive charges in an organic moiety to a CEC of said clay of about 0.75 to about 6.0.

18. The composition according to claim 1 wherein the clay is formed in particles, and wherein the substantially all of the clay particles have a long dimension less than about 1 μm in length.

19. A coated optical fiber comprising:
an optical fiber having a core and at lest one surrounding glass region of refractive index lower than a refractive index of the core; and
a coating which comprises no more than about 55 weight percent of an acrylate oligomer and a substantially exfoliated clay, encircling said cladding, wherein said coating has a Young's Modulus of at least about 100 MPa at room temperature.

20. The fiber according to claim 19 wherein said fiber has an effective area of greater than about 60 μm² at a wavelength of 1550 nm.

21. The fiber according to claim 19 wherein said fiber comprises a fundamental to first higher-order mode Δβ of less than about 7/mm at a wavelength of about 1200 nm to about 1700 nm.

22. The fiber according to claim 19 wherein said exfoliated clay comprises a fully exfoliated clay.

23. The fiber according to claim 19 wherein said exfoliated clay comprises montmorrilonite.

24. The fiber according to claim 19 wherein said coating comprises an epoxy acrylate.

25. The fiber according to claim 19 wherein said coating further comprises at least 40% of a monomeric component.

26. The fiber according to claim 25 wherein said monomeric component comprises at least two monomers.

27. The fiber according to claim 19 wherein said coating comprises a free radical cure coating.

28. The fiber according to claim 19 wherein the clay is formed in particles, and wherein the substantially all of the clay particles have a long dimension less than about 1 μm in length.

29. The fiber according to claim 19 further comprising a primary coating adjacent said cladding and said coating.

30 A method of making an optical fiber coating composition comprising:
dispersing a clay into a low viscosity mixture forming a nanocomposite;
milling said nanocomposite forming a mill;
collecting said mill;
blending an effective amount of a high viscosity component into said mill to form said composition; and
filtering of said composition.

30. The method according to claim 30 further comprising dispersing an organic substance into said clay.

31. The method according to claim 31 wherein said organic substance comprises asurfactant.

32. The method according to claim 30 further comprising repeating said milling step at least once.

33. A method of making a coated optical fiber comprising:
applying a UV curable composition which comprises no more than about 55 weight percent of an acrylate oligomer; and
a substantially exfoliated clay, wherein said composition when cured has a Young's modulus of at least about 100 MPa at room temperature, around an exterior surface of an optical fiber; and
curing said UV curable composition.

34. The method according to claim 33 further comprises applying a primary coating to said exterior of said fiber and curing said primary coating prior to said applying said UV curable composition.

35. The method according to claim 33 further comprising drawing said fiber at a rate of at least about 20 m/s.

36. A method of dispersing a perpendicular force applied to a coated optical fiber comprising the steps of:
coating an exterior surface of an optical fiber with a primary coating;
applying an UV curable composition which comprises no more than about 40 weight percent of an acrylate oligomer; and a substantially exfoliated clay to said primary coating, wherein said composition when cured has a Young's Modulus of at least about 100 MPa at room temperature; and
applying a perpendicular force to said fiber.

37. An apparatus for the measurement of an optical property of an optical fiber segment having an input end and an output end, the apparatus comprising:
an optical source coupled to the input end of the optical fiber segment;
a pair of opposing rack elements including a first rack element and a second rack element, the pair of rack elements being configured to engage the optical fiber segment; and
an optical detector coupled to the output end of the optical fiber segment.

38. The apparatus of claim 37 wherein the rack elements have a generally sawtooth shape.

39. The apparatus of claim 37 wherein the apparatus further includes
a first tensioning line having a first end and a second end, the first end of the first tensioning line being mechanically coupled to the optical fiber segment at a position between the input end of the optical fiber segment and the engaged rack elements;
a first linear actuator, the second end of the first tensioning line being coupled to the first linear actuator;
a second tensioning line having a first end and a second end, the first end of the second tensioning line being mechanically coupled to the optical fiber segment at a position between the engaged rack elements and the output end of the optical fiber segment;
a second linear actuator, the second end of the second tensioning line being coupled to the second linear actuator.

40. The apparatus of claim 37 wherein each rack element has a period selected to produce a microbending effect in the optical fiber segment.

41. A method of measuring an optical property of an optical fiber segment having an input end and an output end, the method comprising the steps of:
coupling an optical signal from an optical source to the input end of the optical fiber segment;
engaging the optical fiber with a pair of opposing rack elements;
coupling the optical signal from the output end of the optical fiber segment to an optical detector;
detecting the optical signal with the optical detector.

43. The method of claim 41 wherein the rack elements have a generally sawtooth shape.

44. The method of claim 41 wherein the optical property measured by the method is selected from the group consisting of Δβ, microbending-induced optical loss, and macrobending-induced optical loss.
